(19) United States
(12) Patent Application Publication
(10) Pub. No.: US 2004/0117202 A1
(43) Pub. Date: Jun. 17, 2004

(54) Method and system for determining benefits

(75) Inventors: Howard Winklevoss, Greenwich, CT (US); James Spaide, New Canaan, CT (US); Debbie Benner, Fairfield, CT (US); Mark Tillman, Stamford, CT (US); Martin Krone, Westport, CT (US)

Correspondence Address: Finnegan, Henderson, Farabow,, Garrett & Dunner, L.L.P., 1300 I Street, N.W., Washington, DC, 20005-3315, US

(73) Assignee: Winklevoss Technologies, LLC

(21) Appl. No.: 10/643,995

(22) Filed: Aug. 20, 2003

Related U.S. Application Data
(60) Provisional application No. 60/433,762, filed on Dec. 17, 2002.

(51) Int. Cl. G06F 17/60

(52) U.S. Cl. 705/1

(57) ABSTRACT

Methods and systems for calculating benefits for defined benefit plans can use a calculation module that receives a request to perform a benefit calculation. The calculation module may use information in the request to identify a system plan from a repository. The system plan may include provisions such as plan rules, formulas, and assumptions associated with a particular benefit plan. Plan providers may establish plan provisions using an expression language, validate the provisions, and load the provisions to the repository. The calculation module may access the system plan, perform benefit plan calculations according to the provisions and using stored benefit data, and generate an output for a user.

### CROSS REFERENCE TO RELATED APPLICATION

This application claims the benefit of U.S. Provisional Patent Application No. 60/433,762, filed Dec. 17, 2002, the disclosure of which is expressly incorporated herein by reference in its entirety.

### TECHNICAL FIELD

This invention generally relates to employee benefit management, and more specifically to methods and systems that allow organizations to calculate post-employment benefits for defined benefit pension plans efficiently.

### BACKGROUND

Often, a successful business plan involves an effective employee reward strategy. One common component of employee reward strategies includes employee defined benefit (DB) plans. A DB plan is a vehicle to provide income to employees in their post-employment years, i.e., upon retirement, termination, death, or for a disability. A DB plan typically changes with government regulations, company acquisitions and divestitures, employer cost, and potential attraction or retention of employees. A DB plan may be any plan, vehicle, and/or arrangement through which beneficiaries receive benefits via a plan provider.

Conventional benefit formulas employed by DB plans can be separated into two main categories: “traditional” and “hybrid.” A traditional DB formula provides a benefit payable as an annuity based on years of service, such as a percentage of salary averaged over the employee's entire career or over just a final period of employment.

Hybrid formulas usually represent benefits as a current account balance that converts to pension benefits upon when employment terminates. Hybrid plans work similar to a defined contribution (DC) or 401(k) plan, where the account is calculated with a percentage of salary, plus interest on the account balance. A plan can use either type of formula, and an existing plan may replace one formula type with another, run both formula types concurrently, or start one formula at a specific conversion point and freeze accruals under another formula.

Due to the varying needs of plan sponsors and the flexibility of DB plans, several DB plans often exist in a given business environment. The number of and variance among DB plans has forced most companies to develop calculation programs for computing benefits. Large companies typically employ conventional programming languages such as C++, JAVA, or COBOL; the smaller firms tend to use EXCEL or similar applications. The creation of these programs usually follows the following five step process: (1) write calculation-specifications; (2) approve specifications by the client; (3) code the calculator; (4) test the calculator; and (5) implement the calculator. The third and fourth steps often repeat as issues and changes are identified.

The development and implementation of these calculation programs has proven both costly and time-consuming. The five-step process typically lasts six to twelve months, depending on the complexity of the calculator, and companies can seldom reuse much code. The cost of a new calculator for an average plan over reaches hundreds of thousands of dollars. Moreover, once the programs are implemented it is often difficult to enhance them in response to design changes, regulatory requirements, or other events.

### SUMMARY

Systems and methods consistent with the present invention enables organizations to set up DB pension plans without entry point programming or exception rule coding and perform all calculations associated with a particular plan all but instantaneously. Systems and methods consistent with the invention may enable a user to create provisions for a DB plan using an expression language, thereby enabling a user without programming language experience to create such provisions. Thus, DB plans can be created in a matter of days instead of months. Moreover, systems of the present invention may be configured to adapt to DB plan changes, regulatory requirements, and/or other events. Systems and methods of the present invention may handle several post-employment benefit contingencies, such as death, disability, retirement, and termination, and such systems may provide users with a complete set of diagnostic reports, including, for example, user inputs and a breakdown of all processed calculations.

Both the foregoing and the following descriptions are exemplary and explanatory only and are not intended to limit the claimed invention in any manner whatsoever.

### BRIEF DESCRIPTION OF THE DRAWINGS

The accompanying drawings, which are incorporated in and constitute a part of this specification, show aspects of the present invention and, together with the description, serve to explain some of the principles associated with the invention. In the drawings:

FIG. 1 is a block diagram illustrating components of one embodiment of the present invention;

FIG. 2 is an exemplary block diagram of a system consistent with certain embodiments of the present invention;

FIG. 3 is another exemplary block diagram of a system consistent with certain embodiments of the present invention;

FIG. 4 is a flowchart depicting an implementation of the present invention in accordance with certain embodiments;

FIG. 5 is a block diagram depicting elements of a system plan consistent with certain embodiments of the present invention;

FIG. 6 is a block diagram depicting exemplary components of a plan definition object consistent with certain embodiments of the present invention;

FIG. 7 illustrates one example of an output file in accordance with certain embodiments of the present invention;

FIG. 8 is a block diagram depicting exemplary components of a benefit definition object consistent with certain embodiments of the present invention;

FIGS. 9A-9H illustrate exemplary expression language consistent with certain embodiments of the present invention;

FIG. 10 is a block diagram summarizing an exemplary construction of a benefit formula object consistent with certain embodiments of the present invention;

FIG. 11 is a block diagram depicting exemplary elements of an accrual definition object consistent with certain embodiments of the present invention;

FIG. 12 illustrates exemplary operators consistent with certain embodiments of the present invention;

FIG. 13 is a block diagram depicting an exemplary interest crediting object consistent with certain embodiments of the present invention;

FIG. 14 is a block diagram showing exemplary components of an eligibility definition object consistent with certain embodiments of the present invention;

FIG. 15 is a block diagram depicting an exemplary date adjustment object consistent with certain embodiments of the present invention;

FIG. 16 is a block diagram depicting an exemplary service definition set consistent with certain embodiments of the present invention;

FIG. 17 is a block diagram showing exemplary service definition objects consistent with certain embodiments of the present invention;

FIG. 18 is a block diagram showing an exemplary service calculation parameters object consistent with certain embodiments of the present invention;

FIG. 19 is a block diagram showing an exemplary service rules object consistent with certain embodiments of the present invention;

FIG. 20 is a block diagram depicting an exemplary event definition object consistent with certain embodiments of the present invention;

FIG. 21 is a block diagram depicting an exemplary salary definition set object consistent with certain embodiments of the present invention;

FIG. 22 is a block diagram depicting exemplary objects of a salary definition consistent with certain embodiments of the present invention;

FIG. 23 is a block diagram depicting exemplary objects of a salary history consistent with certain embodiments of the present invention;

FIG. 24 is a block diagram illustrating an exemplary salary events object consistent with certain embodiments of the present invention;

FIG. 25 is a block diagram illustrating an exemplary payment form object consistent with certain embodiments of the present invention;

FIG. 26 is a block diagram illustrating exemplary objects included in an output consistent with certain embodiments of the present invention;

FIGS. 27A-27C depict an example summary report consistent with certain embodiments of the present invention;

FIGS. 28A-28E depict an exemplary portion of a report including detailed results consistent with certain embodiments of the present invention; and

FIGS. 29A-29E depict an exemplary report providing a summary of results associated with performed calculations consistent with certain embodiments of the present invention.

### DETAILED DESCRIPTION

The following detailed description refers to the accompanying drawings, in which like numerals represent like elements throughout the figures. The accompanying figures illustrate exemplary embodiments and implementations consistent with the present invention, but the description of those embodiments does not indicate or imply that other embodiments or implementations do not fall within the scope of present invention.

Benefit Calculation Overview

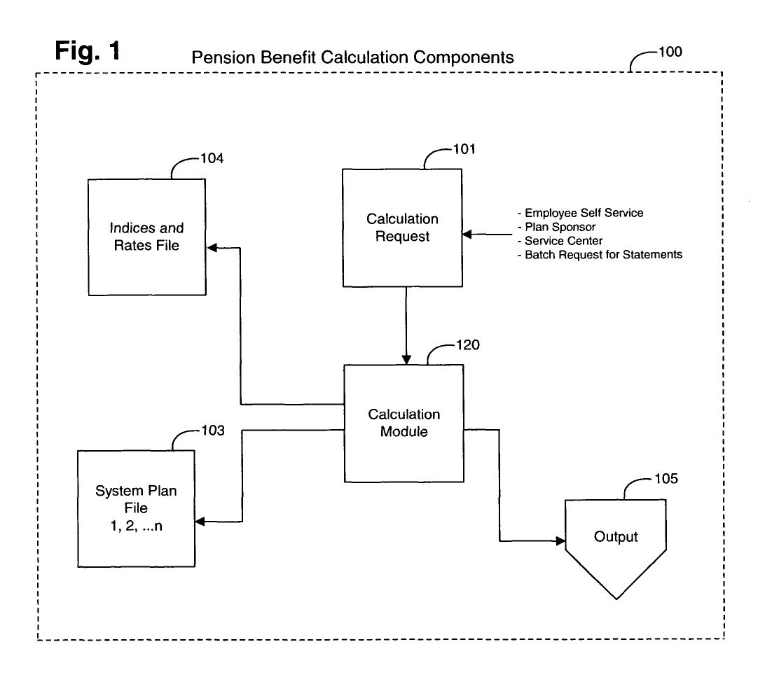

FIG. 1 shows the components for one embodiment consistent with the present invention. A calculation module 120 waits for a calculation request 101 and may have access to information stored in a System Plan file 103 and in an indices/rates file 104. Module 120 may receive calculation request 101 from, for example, the Internet, a company's intranet, a call center application, or a single PC. Request 101 may include information such as system plan identifiers, a beneficiary identifier, type of calculation, decrement dates, benefit commencement dates, and a beneficiary's historical employment data. System plan identifiers may include three fields that the user sets to indicate which set of plan rules to execute. The fields could be based on how the user differentiates between pension plans, beneficiaries and calculation type. The discussion below identifies additional information in request 101.

Once calculation module 120 receives request 101, it may initiate a call to System Plan file 103 for the retrieval of the plan rules, formulas, and assumptions, and a call to the rates and indices file 104 to retrieve the historical interest rates, economic indices, and regulatory limits. Consistent with principles of the invention, such rules, formulas, and assumptions may be created by a user via an expression language and associated with System Plan file 103. System Plan file 103 may be identified by the system plan identifiers supplied in request 101. Calculation module 120 will then perform all of the required calculations and produce output 105. Output 105, which is discussed in detail below, may include the pension benefit payable for all contingencies and all payment forms for which the beneficiary is eligible as well as sample life output for calculation diagnostic purposes.

Calculation module 120 may be configured to support the needs of beneficiaries (e.g., employees) and plan providers (e.g., employers); and beneficiaries could use the plan rules and formulas for evaluating possible future retirement dates and individual retirement planning. Plan providers can use the pension benefit payable information to support production of benefit statements, the determination of post employment benefits to start monthly disbursements to an employee, or other mailing and employee educational materials.

System Overview

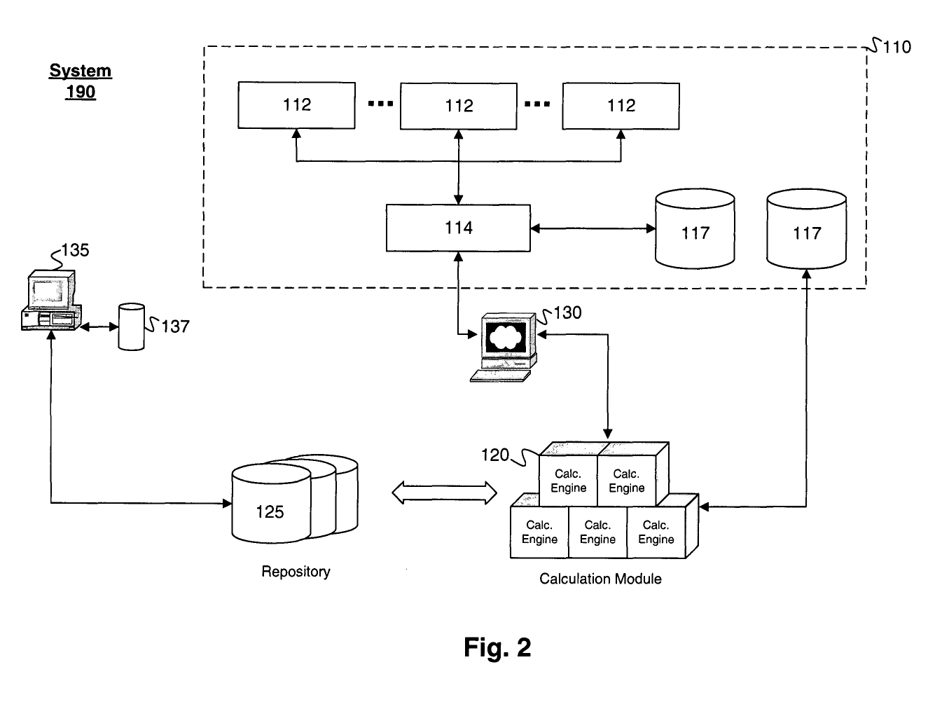

FIG. 2 illustrates an exemplary system 190 in which features and principles of the present invention may be implemented. System 190 may include a plan provider infrastructure 110, a calculation module 120, a repository 125, a network server 130, and a data processing system 135.

Plan provider infrastructure 110 may include any combination of components, devices, and mechanisms employed and/or maintained by a plan provider. The term“plan provider” refers to any entity that sponsors, provides, maintains, offers, and/or administers DB plans. Examples of plan providers include actuarial firms, human resource departments, and outsourcing firms that provide services to the defined benefit pension market. Plan providers may also include corporations, firms, enterprises, small businesses, public/private organizations, governmental organizations, educational institutions, hospitals, service providers, and retail organizations. In certain embodiments, a DB plan may be a legal document that details all of the rules and formulas that pertain to a beneficiary's entitlement to benefits.

As used in this description, a“benefit” may include any possession having commercial or exchange value, such as currency, real property, intangible property, shares, options, futures on stocks, bonds, commodities, or indices. DB plan beneficiaries may include employees, members, organizations, or any other individual, entity, and/or organization associated with a particular plan provider. Beneficiaries may also designate secondary beneficiaries to receive benefits from a DB plan. Secondary beneficiaries could include family members or other individuals or entities related to or specified by a beneficiary.

For example, a plan provider may be an entity, such as an employer, who provides DB plans directly to its own employees. Plan providers could also be entities that maintain or administer DB plans for employees associated with one or more independent plan sponsors. For example, a plan provider could be responsible for administering and maintaining DB plans for other employers.

As FIG. 2 illustrates, plan provider infrastructure 110 may include one or more access points 112, a user data layer 114, and information databases 117. Access points 112 may include any system, device, or service through which a user associated with plan provider infrastructure 110 can initiate a request (e.g., request 101) to calculation module 120. Other examples of access points 112 include a Voice Response Unit (VRU), a call center, a single computer or workstation, and/or a network (e.g. an intranet, internet, etc).

Information databases 117 may be maintained by a DB plan provider and contain information (e.g., rates and indices 104) associated with DB plans. Information databases 117 may store information used by calculation module 120 for performing DB plan calculation such as census information, market rates, historical interest rates, economic indices, or regulatory provisions (e.g., provisions of the U.S. Internal Revenue Code).

Infrastructure 110 may include one or more user data layers 114 coupled to other components in infrastructure 110. User data layer 114 may serve as an integration layer that enables calculation module 120 to interact with components in provider infrastructure 110. For example, user data layer 114 may be an Application Program Interface (API), such ActiveX Data Objects (ADO), which enables calculation module 120 to interact with information databases 117.

Calculation Module

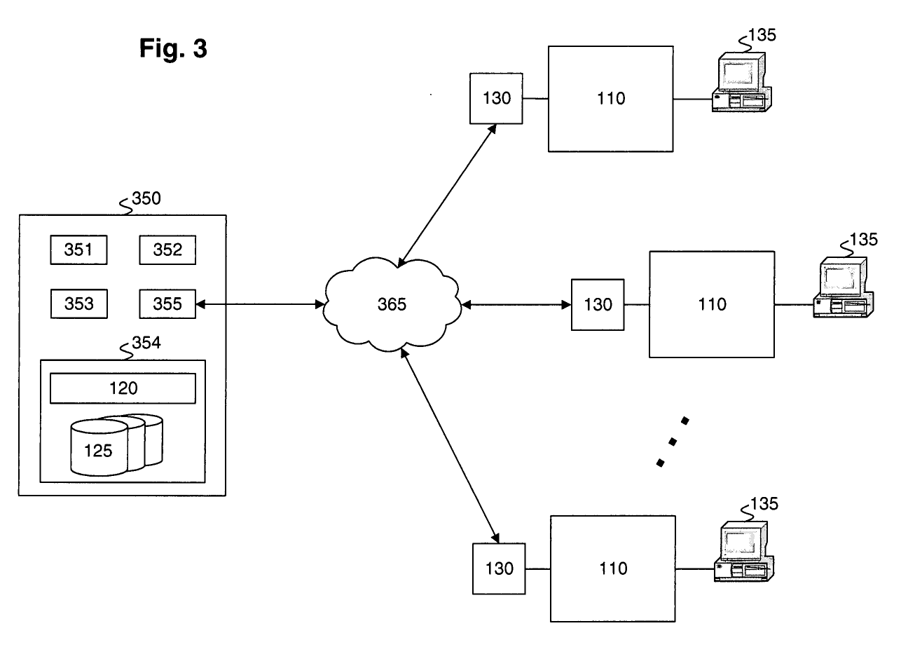

Plan provider infrastructure 110 may include or be coupled to calculation module 120 and repository 125. Calculation module 120 may be any device, mechanism, algorithm, or combination of instructions operable to calculate benefits associated with one or more DB plans. Calculation module 120 may also be configured to perform support functions associated with administering, maintaining, or distributing benefits of one or more DB plans. Consistent with principles of the present invention, calculation module may be configured to adapt to DB plan changes, design changes, regulatory requirements, and/or other events. In response to DB plan changes, regulatory requirements, design changes, and/or other events, corresponding objects may be easily updated, and calculation module 120 may adapt to the changes. Calculation module 120 may, in certain embodiments, be implemented via one or more application software modules. In one example, such application software could reside in or be distributed among one or more dedicated data processing systems having components similar to those described below in connection with calculation server 350 (see FIG. 3).

In one embodiment of the invention, calculation module may be configured to interact with plan provider infrastructure 110 via a network server 130, which may also include components similar to those described below in connection with calculation server 350 of FIG. 3. Additionally, in certain implementations of the present invention, the eXtendable Markup Language (XML) may be employed to facilitate the data exchange between calculation module 120 and components in plan provider infrastructure 110. Additionally, or alternatively, the Standard Generalized Markup Language (SGML) and/or any other language that facilitates the creating and sharing of common information formats may be employed to facilitate such data exchange.

Consistent with principles of the present invention, calculation module 120 may include one or more processors and/engines for performing data computation. For example, as illustrated in FIG. 2, calculation module may include five distinct calculation engines. The number of calculation engines or processors may vary with different implementations and depend on the type of environment with which calculation module 120 is interacting. For example, if calculation module 120 is implemented or interacting with a quad box, then it may include four engines/processors. Consistent with principles of the present invention, calculation module 120 may interact with repository 125 to access and retrieve information associated with DB plans.

Repository

Repository 125 may be any device, mechanism, or structure configured to store, maintain, and provide access to DB plans and their associated provisions. In exemplary embodiments, repository 125 may maintain system plans for DB plans. A system plan may define the inputs, outputs, and provisions associated with a given DB plan. Repository 125 may be a file structure residing on or distributed among one or more network drives accessible by calculation module 120, but the implementation is not important. Repository 125 may also include one or more databases maintaining DB plan provisions. Repository 125 may also include or employ RAM, ROM, magnetic and optical storage, organic storage, audio disks, and video disks.

Consistent with principles of the present invention, a plan provider can generate DB plan provisions via data processing system 135. Data processing system 135 may include one or more standalone devices through which a user associated with a plan provider can access, setup, or alter DB plans. Examples of data processing system 135 include a laptop computer, desktop computer, workstation, mobile computing device (e.g., a PDA), mobile communications device (e.g., a cell phone), or any other structure that enables a user to process information associated with a DB plan.

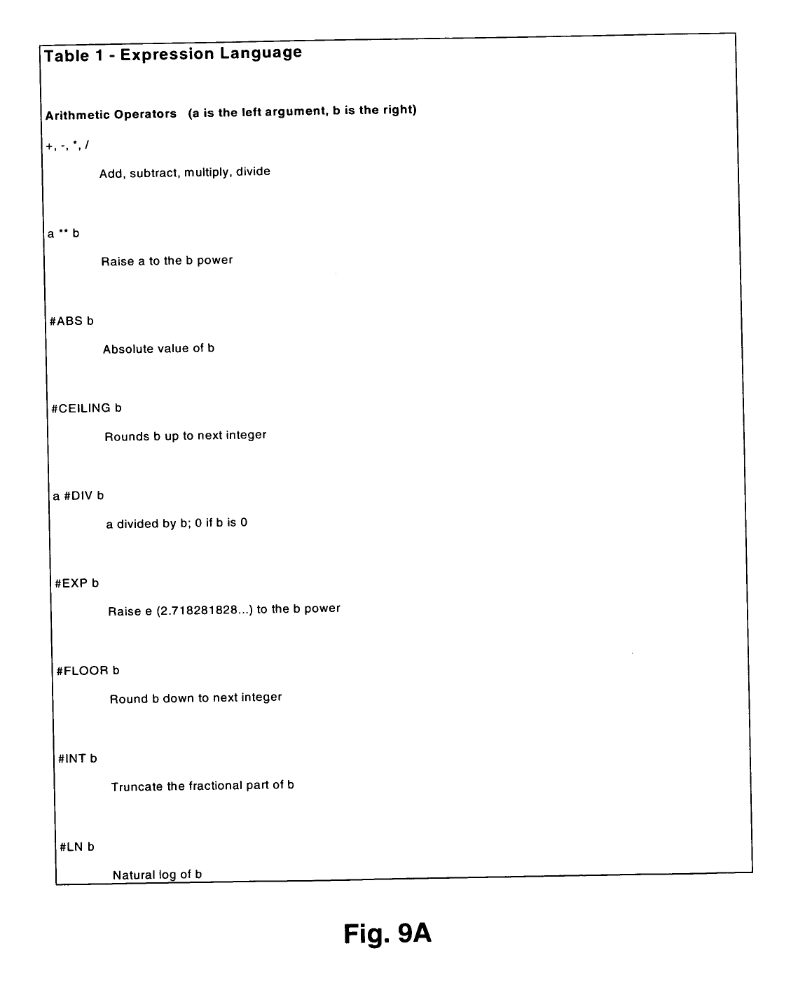

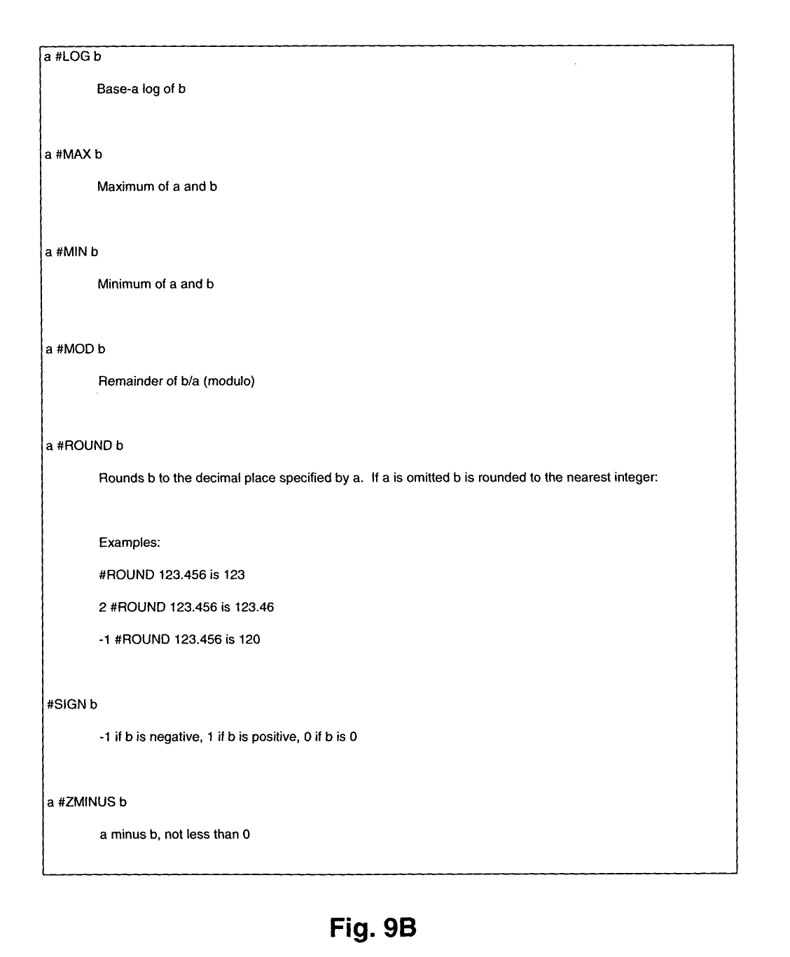

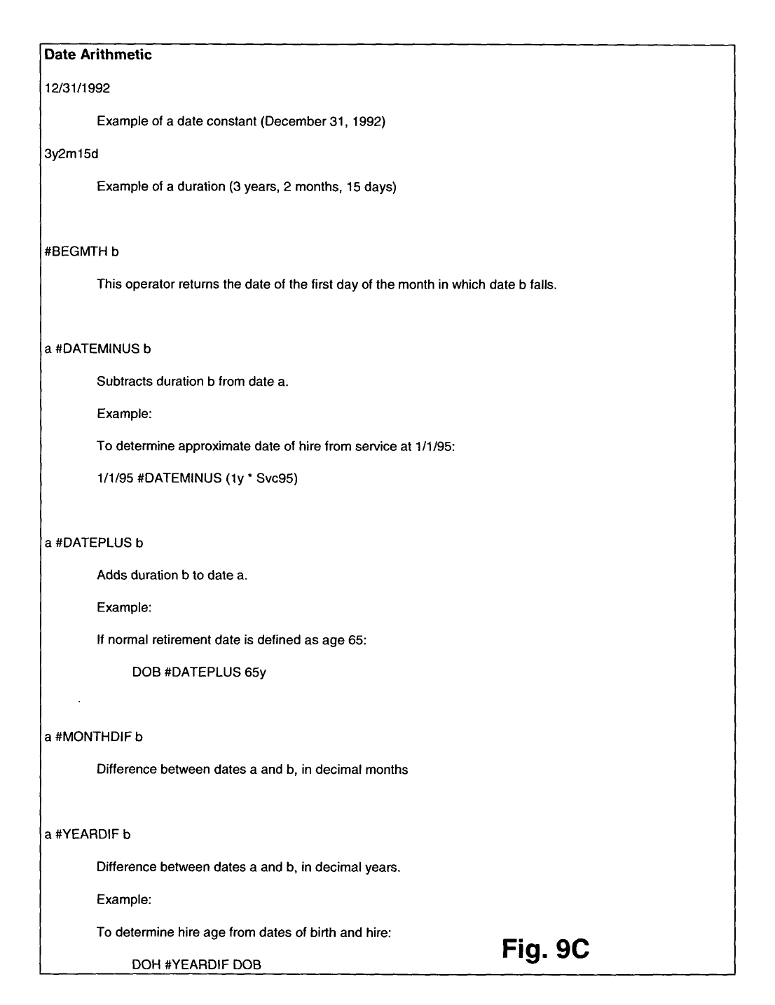

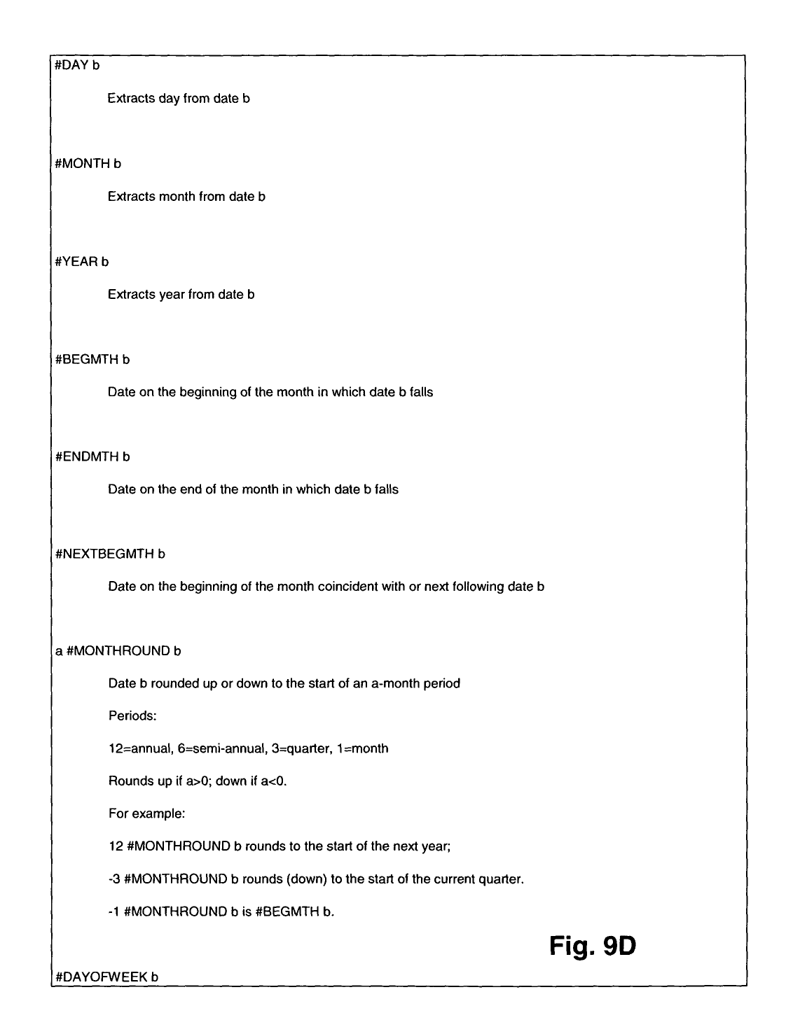

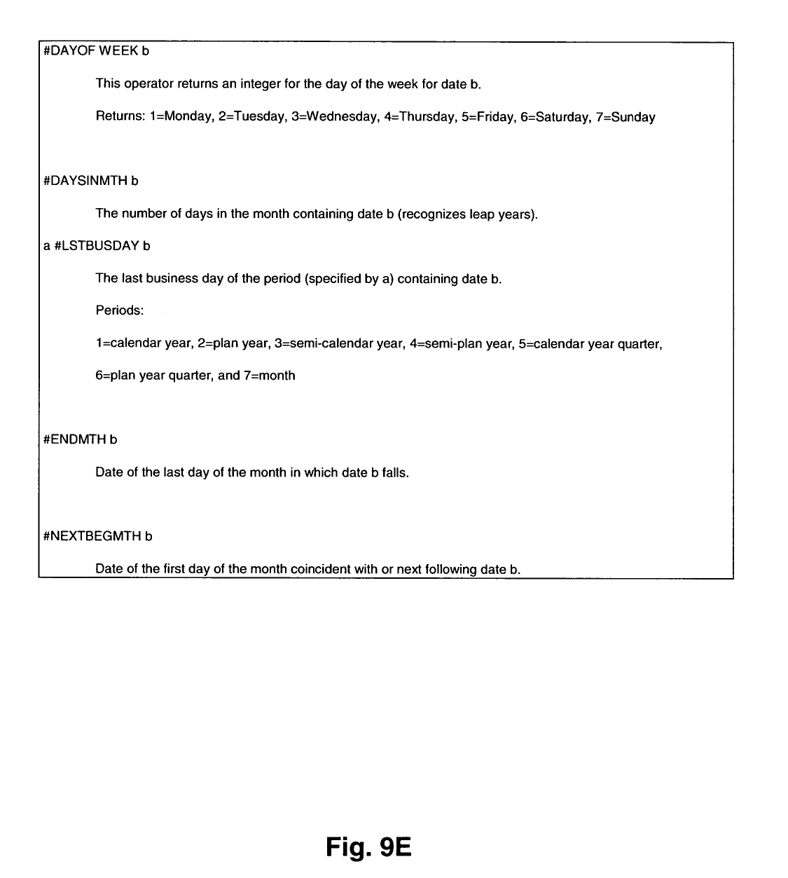

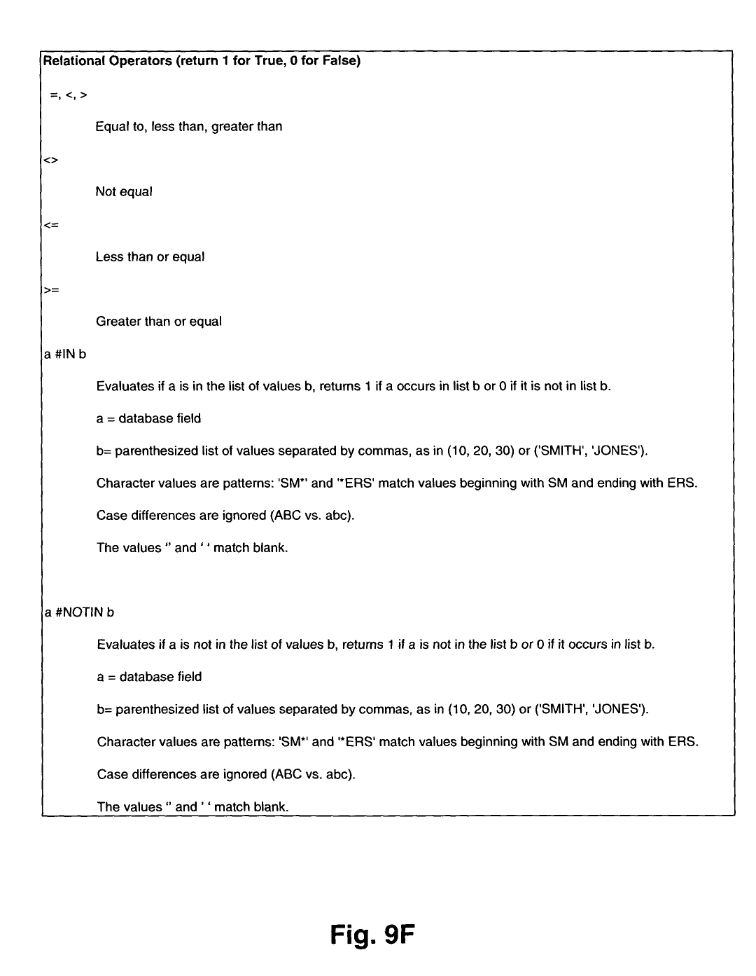

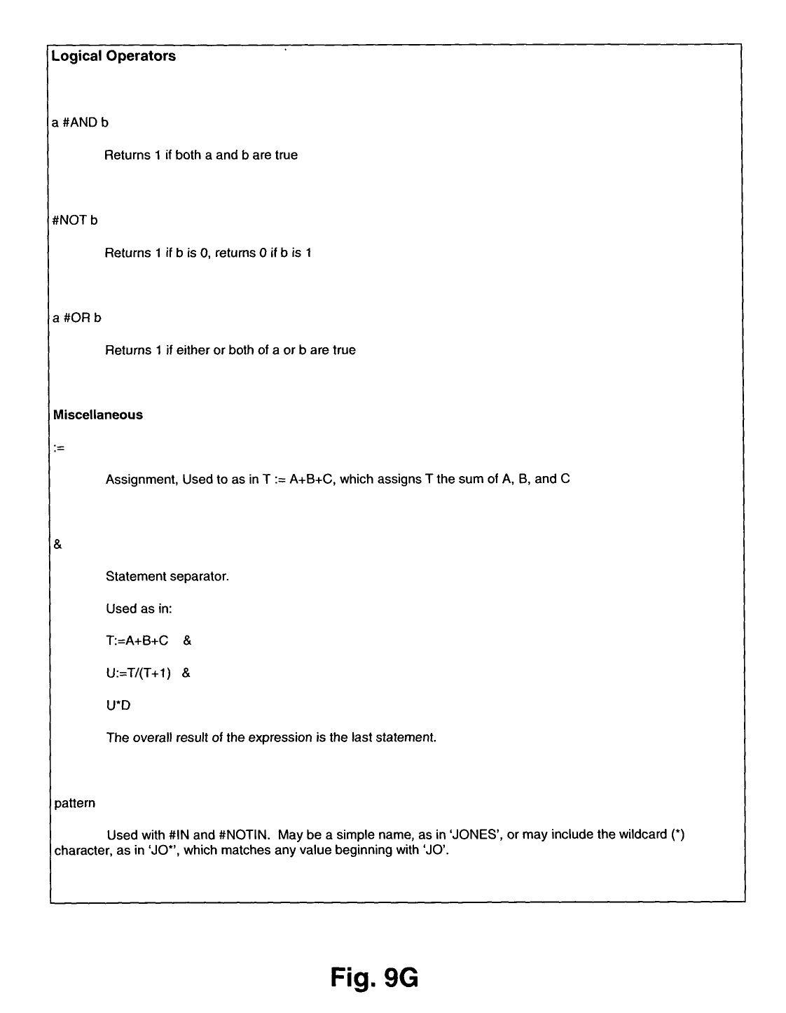

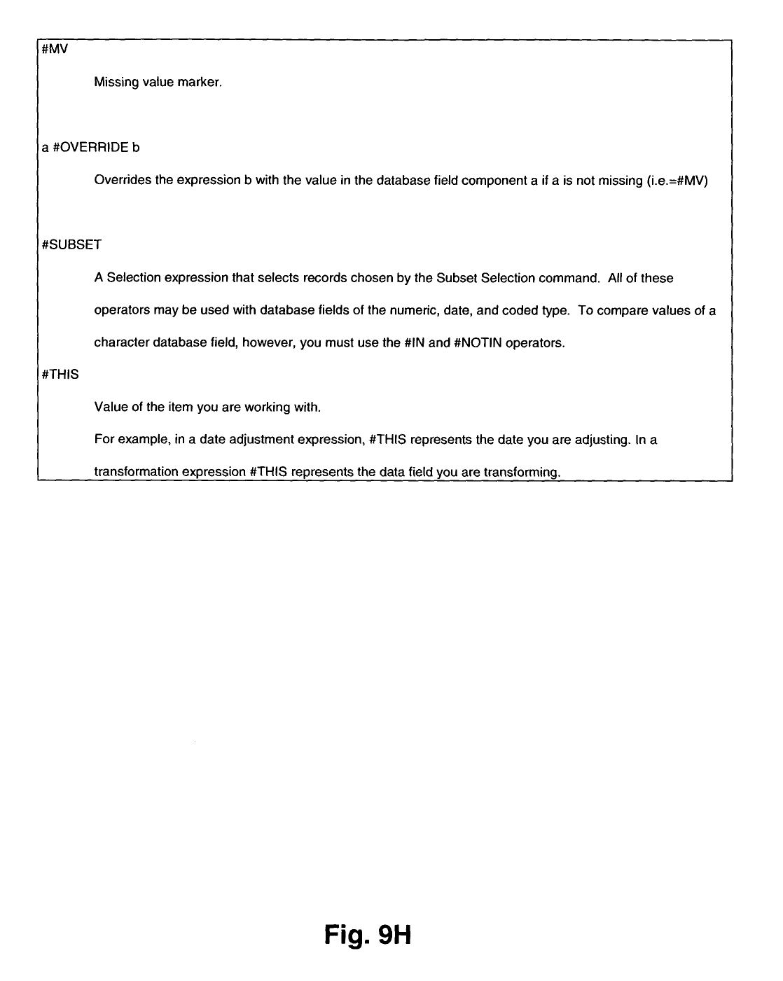

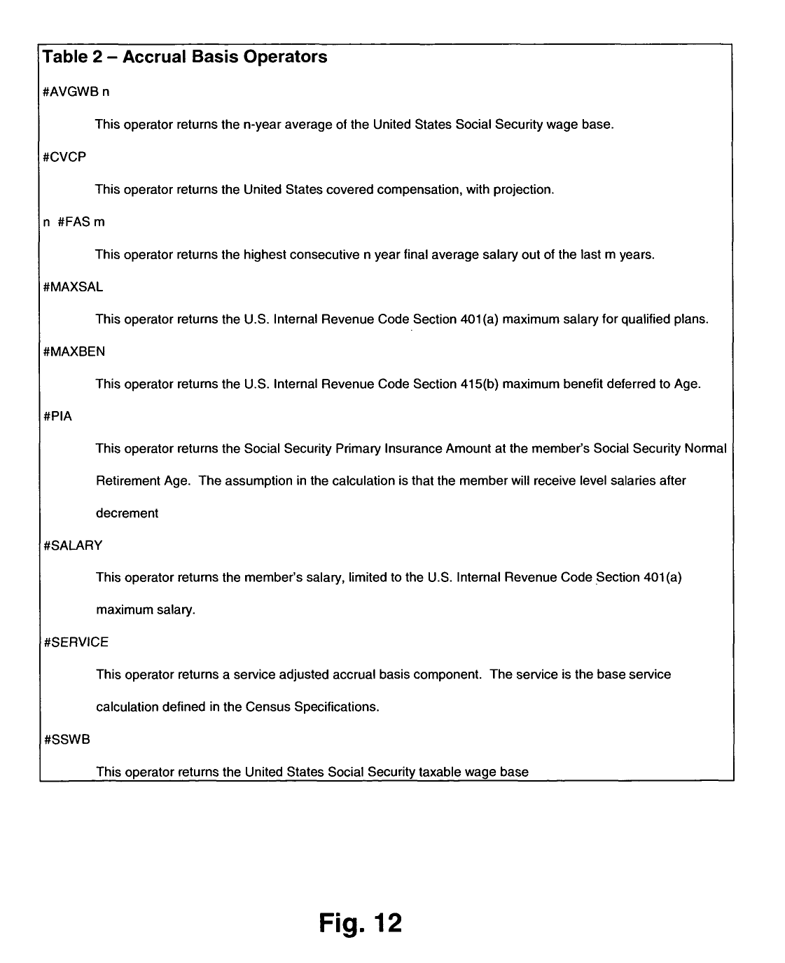

Consistent with principles of the invention, a user can generate plan provisions (e.g., 137) via an expression language, which may be provided through data processing system 135. As used herein, the term “provisions” refers to assumptions, rules, requirements, and/or formulas associated with a given DB plan. The “expression language” may be a lexicon of built-in and/or user-defined (or user-named) elements including arithmetic operators, relational operators, logical operators, data arithmetic, and/or other operators, data components, and/or logic used by calculation module 120 or one or more other components of system 10. Table 1 of FIG. 9 and Table 2 of FIG. 12 list exemplary elements of an expression language which may be used in certain embodiments of the present invention. Users may setup DB plans via the expression language and an associated user interface, both of which may reside on or be coupled to data processing system 135.

In one embodiment of the present invention, a Graphical User Interface (GUI) may be configured to interact with the expression language and may enable a user to create DB plan provisions (e.g., a benefit formula), via the expression language, with elements such as pull-down menus, text boxes, selection boxes, icons, combo boxes, spinners, progress indicators, on-off checkmarks, scroll bars, windows, window edges, toggle buttons, and forms. In addition or as an alternative to a GUI, other types of user interfaces may be employed to enable users to exploit the expression language. In one embodiment, plan provisions 137 may serve as a prototype DB plan with which the user can, prior to loading the DB plan to repository 125, run simulations, testing, and/or analysis.

FIG. 2 and the accompanying text describe exemplary implementations of system 190. The functionality of each element in FIG. 2 may be present in one or more other elements, and may be realized by more or fewer elements that in FIG. 2. Moreover, all or part of the functionality of the elements illustrated in FIG. 2 may even be distributed among several geographically dispersed locations, and the arrangement of elements may even vary from the configuration illustrated in FIG. 2, and all of the illustrated elements may be included within a given plan provider infrastructure 110. In addition, data processing system 135 may reside within plan provider infrastructure 110, or calculation module 120 may interact with (or receive requests from) users without an intermediate network server. Moreover, server 130 may be absent from certain system configurations, and infrastructure 110 may lack certain illustrated components and/or contain, or be coupled to, additional components not shown.

Moreover, although FIG. 2 depicts a data processing system 135, a single plan provider infrastructure 110, a single calculation module 120, and a single repository 125, system 10 may include any number of geographically dispersed data processing systems 135, infrastructures 110, calculation modules 120, or repositories 125. Calculation module 120 could therefore be configured to interact with several plan providers simultaneously or individually.

FIG. 3 shows another implementation consistent with the present invention in which calculation module 120 is configured to interact with several plan providers. Calculation module 120 and repository 125 may reside in a calculation server 350, which is coupled to a network 365. Also, a plurality of geographically dispersed plan provider infrastructures 110 may be coupled via network servers 130 to network 365. In this fashion, a third party could maintain a single calculation server 350 that could interact with a plurality of plan providers and/or sponsors.

As FIG. 3 shows, calculation module 120 and repository 125 may be implemented via application software in a server such as calculation server 350. One combination of components that could reside in calculation server 350 includes a display device 351, an input device 352, a processor 353, a memory 354, and a network interface 355.

Display device 351 may be any type of output device configured to output data (e.g., text, images, code, or any other type of information). For example, display device 351 may include a cathode ray tube, liquid crystal display, light-emitting diode display, gas plasma display, or other type of display mechanism. Display device 351 may be used in conjunction with input device 352 to enable a user to interact with one or more processes executed by calculation server 350.

Input device 352 may be any type of input mechanism used to provide data to calculation server 350, such as a keyboard, a mouse, and/or a touch screen. Input device 352 may additionally or alternatively include a data reading device and/or an input port.

Processor 353 may be one or more devices operatively configured to execute program instructions. Processor 353 may be configured for routing information among components and devices and for retrieving and executing computer instructions in memory 354. Processor 353 may be configured to execute instructions received from, or resident in, calculation module 120.

Memory 354 may be any mechanism capable of storing information including RAM, ROM, magnetic and optical storage, organic storage, audio disks, and video disks. Although a single memory device 354 is shown, any number of memory devices may be included in calculation server 350, each configured for performing distinct functions associated with the system.

As FIG. 3 illustrates, calculation server 350 may be connected to network 365 via network interface 355, which may be operatively connected via a wired and/or wireless communications link. Network interface 355 may be any mechanism for sending information to and receiving information from network 365, such as a network card and an Ethernet port, or to any other network such as an attached Ethernet LAN, serial line, etc. Network interface 355 may be configured for translating data received from network 365 and formatting outgoing data. For example, network interface 355 may include or be coupled to an ATM Adaptation Layer (AAL) circuit.

Network 365 may be the Internet, a virtual private network, a broadband digital network, a local area network (LAN), a wide area network (WAN), a dedicated intranet, or any other structure for enabling communication between two or more remote locations. Network 365 may also include one or more wired or wireless based connections. Network 365 may also employ communication protocols such as HyperText Transfer Protocol (HTTP), Transmission Control and Internet Protocol (TCP/IP), Asynchronous Transfer Mode (ATM), Ethernet, or any other compilation of procedures for controlling communications among network locations. Calculation server 350 may be operatively connected to network 365 by one or more communication devices and software, such as those commonly employed by Internet Service Providers (ISPs) or as part of an Internet gateway. Systems and devices coupled to and included in network 365 may be assigned network identifiers (ID), which may, in one configuration, be encoded as IP addresses. As used herein, the term “ID” refers to any symbol, value, tag, or identifier used for addressing, identifying, relating, or referencing a particular network device.

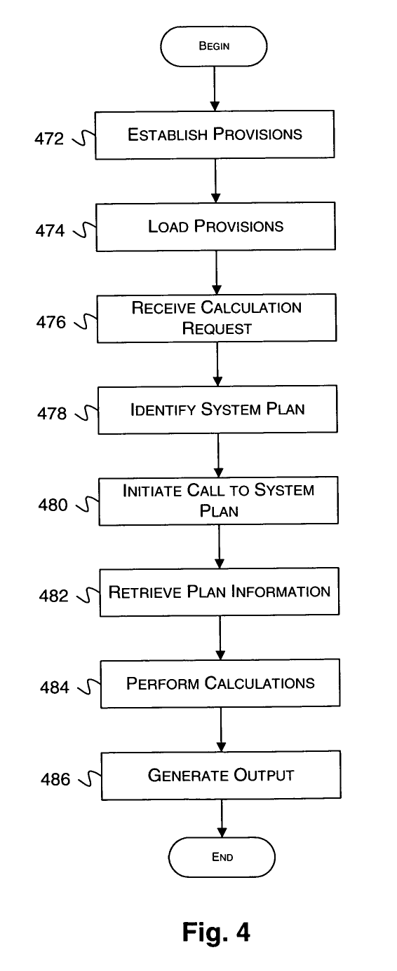

FIG. 4 is a flowchart depicting one implementation consistent with the present invention. In one embodiment of the present invention, plan providers may establish DB plans (stage 472). For example, a user associated with a plan provider may set up DB plan provisions via data processing system 135. Consistent with principles of the present invention, the DB plan provisions may be created by the user via an expression language and corresponding interface (e.g., GUI). The user may then validate the provisions. In one embodiment, the user may validate, via data processing system 135, provisions using a GUI, which may be configured to interact with validation software residing on data processing system 135 and/or calculation module 120. Further details regarding validation are discussed below. After provisions for a particular DB plan are validated, the provisions may be transmitted (or loaded) from data processing system 135 to repository 125 and associated with a system plan corresponding to that DB plan (stage 474).

A calculation request may then be received (stage 476). Calculation module 120 may be configured to receive a calculation request (e.g., request 101) from one or more access points 112. For example, calculation module 120 could receive a request from a PC or VRU within plan provider infrastructure 110. The calculation request may be routed from an access point 112 to calculation module 120 via web server 130 or from an access point 112 to calculation server 350 via network 365. The path of such requests is not critical.

As explained above, the system plan identifier may be three fields that a user can set to indicate which set of plan rules to execute. System plan identifier fields may include, for example, a plan identifier, location identifier, transaction type, and job classification. The beneficiary identifier may be a field that uniquely identifies the beneficiary within the DB plan; this may be an employee number, Social Security Number, clock number or union number.

Calculation module 120 may be configured to perform two types of calculations: finals and estimates. Finals may be calculations performed when information is complete and accurate from the beneficiary's employment data as of the decrement date. Estimates may use assumptions for missing data in accordance with plan parameterization. As used herein, the term “decrement” date refers to a date at which a beneficiary is no longer actively associated (or employed) by a plan provider or employer. The benefit commencement dates may be the date that benefits are expected to begin. Calculation module 120 may process calculations for any number of decrement dates and commencement dates.

Upon receiving a calculation request (stage 476), calculation module 120 may identify a system plan (stage 478), which may contain the provisions (e.g., plan rules, formulas, and assumptions) associated with the particular DB plan. The system plan may also define inputs and output associated with the DB plan. The system plan (e.g., 103) may be identified by the system plan identifiers supplied in the calculation request. In stage 478, calculation module 120 (or some other module) may also identify a type of calculation to be performed or information associated with a particular beneficiary (e.g., Social Security Number, employee number, etc.). Once the appropriate system plan is identified, calculation module 120 may initiate a call to the system plan (stage 480) for the retrieval of the provisions (e.g., plan rules, formulas, and assumptions). System plans may be stored in repository 125, and initiating a call may involve initiating a call to repository 125.

After identifying the appropriate system plan and initiating a call, plan information may be retrieved (stage 482). Calculation module 120 may retrieve system plan provisions from repository 125 via the identified system plan. Additionally or alternatively, calculation module 120 may access (via data layer 114) databases 117 and 119 to retrieve benefit data such as historical interest rates, economic indices, and regulatory limits.

Upon obtaining the plan information (provisions and/or benefit data) associated with a particular DB plan, calculation module 120 may perform calculations (stage 484) and produce an output (stage 486), such as output 105. In one embodiment, calculation module may produce the output according to the identified system plan. The production of an output in stage 186 may include presenting or displaying (e.g., via access point 112) pension benefit payable for all contingencies, payment forms for which the beneficiary is eligible, or sample life output for calculation diagnostics.

Other method steps may be used instead of those in FIG. 4, and the order of events in FIG. 4 may vary without departing from the scope of the present invention. For example, calculation module 120 may receive a calculation request (stage 476) for a particular DB plan while a user is concurrently establishing provisions (stage 472) for another DB plan. In addition, calculation module 120 could communicate (or retrieve plan information (stage 482)) several times or even continuously to perform calculations requested in the calculation request.

Exemplary Objects

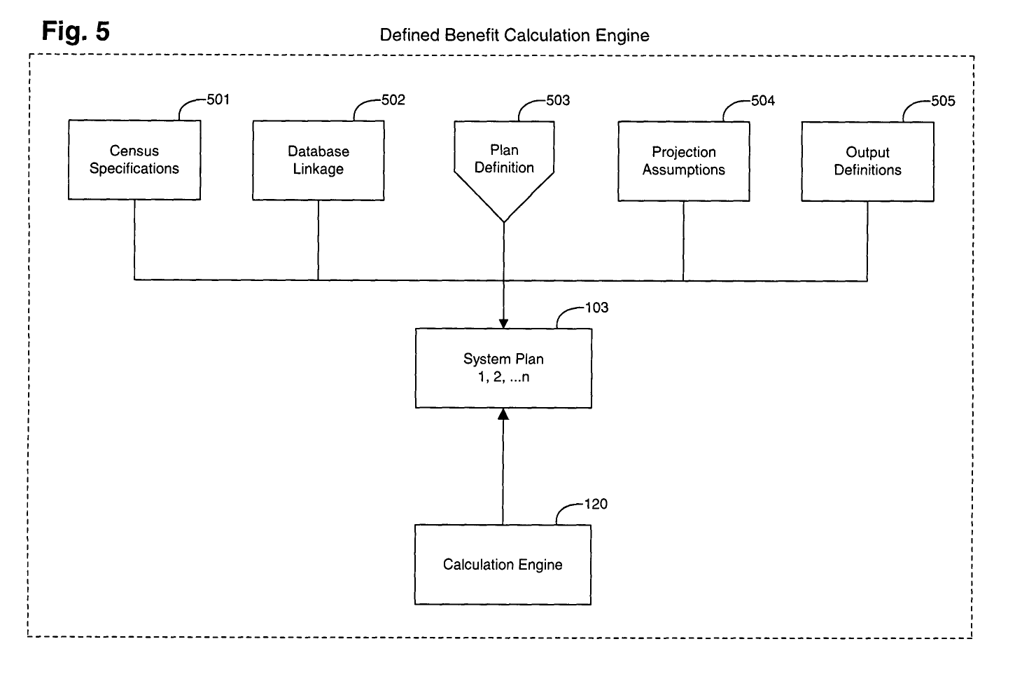

Consistent with principles of the present invention, a flexible calculation module (120) may be used in conjunction with an expression language to create provisions and determine benefits for DB plans. DB plan provisions may be generated via the expression language and corresponding interface, without cumbersome entry point programming or exception rule coding. Further, when a DB plan change, regulatory requirement, and/or other event occurs, corresponding objects can easily be updated. In this fashion, the calculation module may adapt to DB plan changes, and plan providers may manage such changes without re-developing and implementing calculation programs. FIGS. 5-26 illustrate exemplary objects consistent with certain embodiments of the present invention.

FIG. 5 is a block diagram depicting elements of a system plan (e.g., 103). Consistent with the present invention, a particular system plan may define all of the rules, formulas and assumptions associated with a given DB plan, or may not. For example, as illustrated in FIG. 5, System Plan 103 may comprise Census Specifications 501, a Database Linkage 502, a Plan Definition 503, Projection Assumptions 504, or Output Definitions 505. A user associated with a plan provider may wish to obtain a final calculation and an estimate from calculation module 120, where the final calculation might include detailed calculation results as well as available forms of payment. Under such a scenario, two-system plan objects may be created, each object using the same census specifications, plan definitions, projection assumptions, and database linkage but having different output definitions. The system plan identifiers might use the calculation type to determine that one set is executed for estimates and the other for final calculations.

Census Specifications 501 may create a relationship between fields of a data dictionary and fields required for the beneficiary, and may allow for the setup of data validation rules and potential data defaults. As used herein, the term “data dictionary” refers to a lexicon of information that includes data fields, which may be user-specified and available for use in calculations performed by calculation module 120. For example, Company A may choose to refer to a beneficiary's date of birth with a field named “DOB” whereas Company B may choose to use “BirthDate.” Census Specifications 501 may allow a user to identify the named data dictionary fields that contain specific information required by calculation module 120. For example, Census Specifications 501 may include references to the fields containing the beneficiary's date of birth and sex, and the type of beneficiary (self, spouse, non-spouse, none, etc.). Census Specifications object 501 may enable the present invention to adapt to each client (e.g., plan provider) and may avoid adherence to a single naming scheme or convention.

Data validation rules may be, for example, user-defined data checks for ensuring accurate input to calculation module 120. Calculation module 120 may also be configured to perform self-checks. The data checks may allow a user to interrogate data included in a calculation request. Pre-defined functions may enable the user to create and run various edit scenarios. For example, the user can reference a field set up in the data dictionary and use a function from the list shown in FIGS. 9A-9H to create data checks. In one example, a user may wish to ensure that members that have already been paid the full value of their benefits do not process through the calculation module. To accomplish this, a data check can be written to interpret the data. For instance, a field labeled “current₁₃ status” may indicate an employee's current employment status, and a value of 99 may indicate that the member was paid out in a lump sum and is no longer entitled to benefits. The user could, for example, write an expression similar to “current₁₃ status =99” and set the message that is returned when this check is met.

In certain embodiments, different messages may be associated with the data checks and displayed for different calculation types (e.g., finals and estimates). As an example, a check for beneficiary birth dates prior to Jan. 1, 1900 can cause a warning condition for estimates, but be considered an error for final calculations. Warning conditions may enable calculation module 120 to continue performing calculations and return a corresponding warning message. Error conditions may stop the calculation process and return a message associated with the data validation.

In certain implementations consistent with the present invention, a “data default” may create values for data dictionary fields when expected data is missing. For example, a particular database (e.g., information database 117) associated with a plan provider may have a field labeled “officer” that is created when a particular beneficiary becomes an officer of a company. In such a case, a user could create a condition that sets the “officer” field to “no” (as a data default) whenever the field is not populated. This functionality may obviate the need to establish condition logic for data fields that may or may not contain values at any given time.

Database Linkage 502 may associate data dictionary fields with data (which may be XML-tagged) included in a calculation request (e.g., 101). For example, the data dictionary may include a data field for the beneficiary's date of hire labeled “DOH,” which may be used in various calculations. In such a case, the XML tag <DOH> in the calculation request data may precede the data of hire, and the Database Linkage 502 may inform calculation module 120 which data in the request populates the field. The XML tags and the data dictionary names may be unique to each plan provider, and may be based on individual plan provider preferences. The data dictionary may include any number of fields, but calculation module 120 may only populate those input fields necessary to calculate a beneficiary's benefits based on the rules and formulas included in Plan Definition 503. Database Linkage 502 may facilitate customization of system 10 to a plurality of plan providers with minimal setup time.

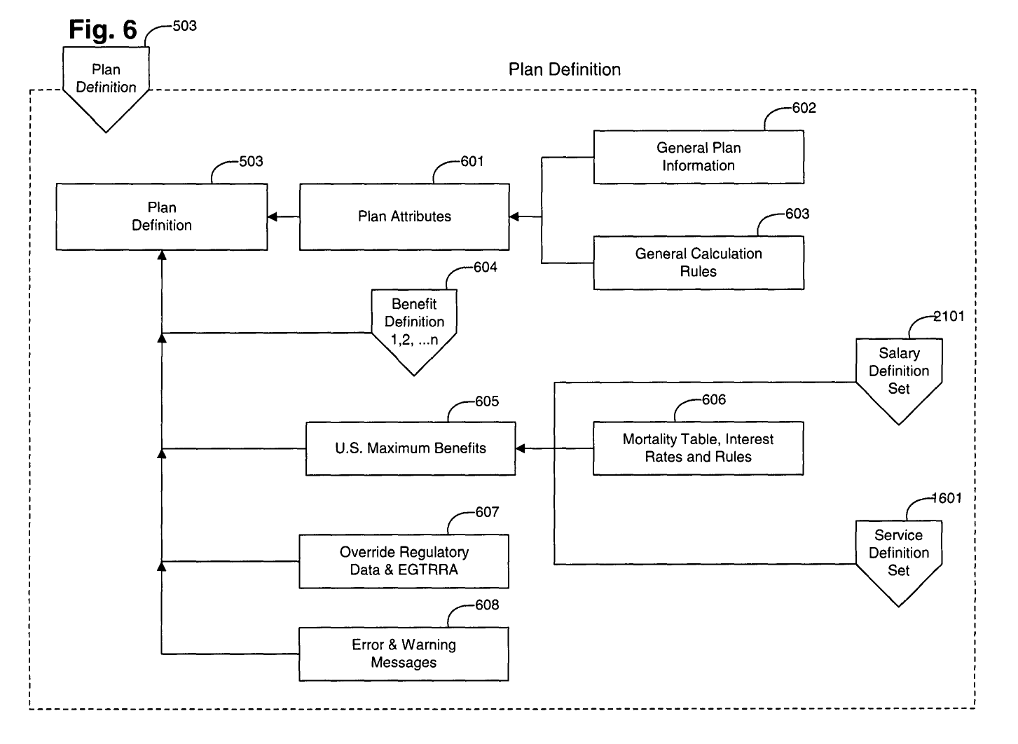

Plan Definition 503 may include or establish rules and formulas for a given DB plan. FIG. 6 shows exemplary objects in Plan Definition 503. Projection Assumptions 504 may establish rules for calculating future data, from the last available information through the decrement date. In certain instances, member calculation data may be available through a specific point in time. For example, active employee data may span the end of the last month's payroll reporting cycle through the actual termination date. If an active member requests a calculation with a termination date of Dec. 31, 2008 and the actual member data is available only through Apr. 30, 2003, Projection Assumptions 503 is used to determine how to construct data from Apr. 30, 2003 through Dec. 31, 2008. Projection Assumptions 504 may also set the rules for the calculation of future salary accruals, future service accruals, changes in historical indices, or assumptions for future interest rates. In certain implementations, these rules may be used primarily for estimate calculations performed by calculation module 120.

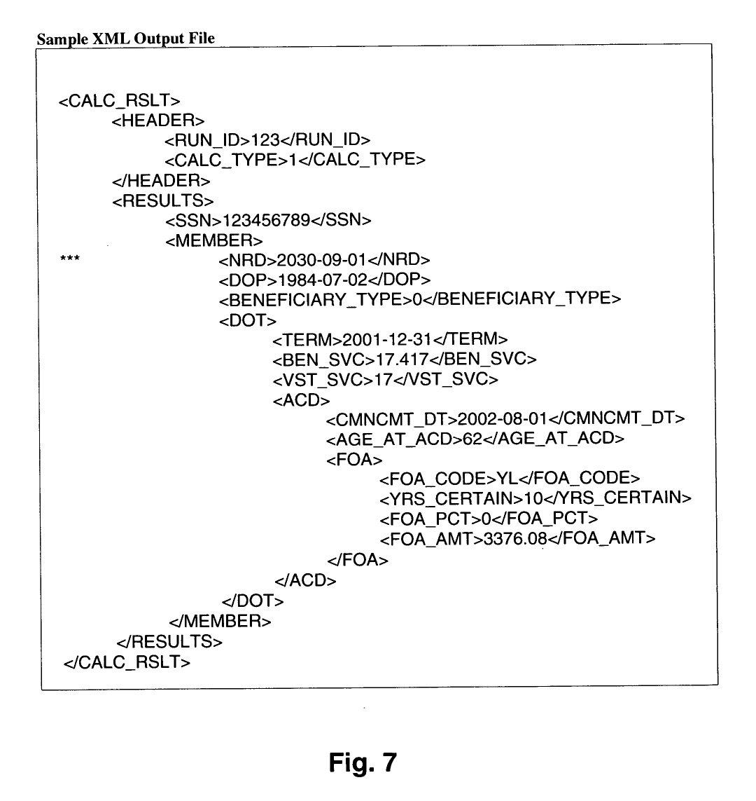

Consistent with principles of the present invention, Output Definition 505 may build one or more relationships between executed calculations and an output document, which, for example, could be XML-tagged. In certain implementations, this may be realized by objects similar to the Database Linkage 502. The relationships between executed calculations and the output document may allow calculation module 120 to produce a unique output document for each System Plan 103 object satisfying an Output Definition 505. Information in Output Definition 505 may include calculation results (e.g., benefit or service), XML field names, data types (e.g., number or date), and instructions for handling multiple mappings. For example, a DB plan may have a normal retirement definition of age 65 with 5 years of employment, and the user may want to output the expected normal retirement date. To accomplish this, an eligibility definition may calculate the eligibility date, and the Output Definition 505 could have entries referencing the eligibility definition, the XML tag: “<NRD>”, and the “date” data type. FIG. 7 shows a sample XML output document consistent with the present invention.

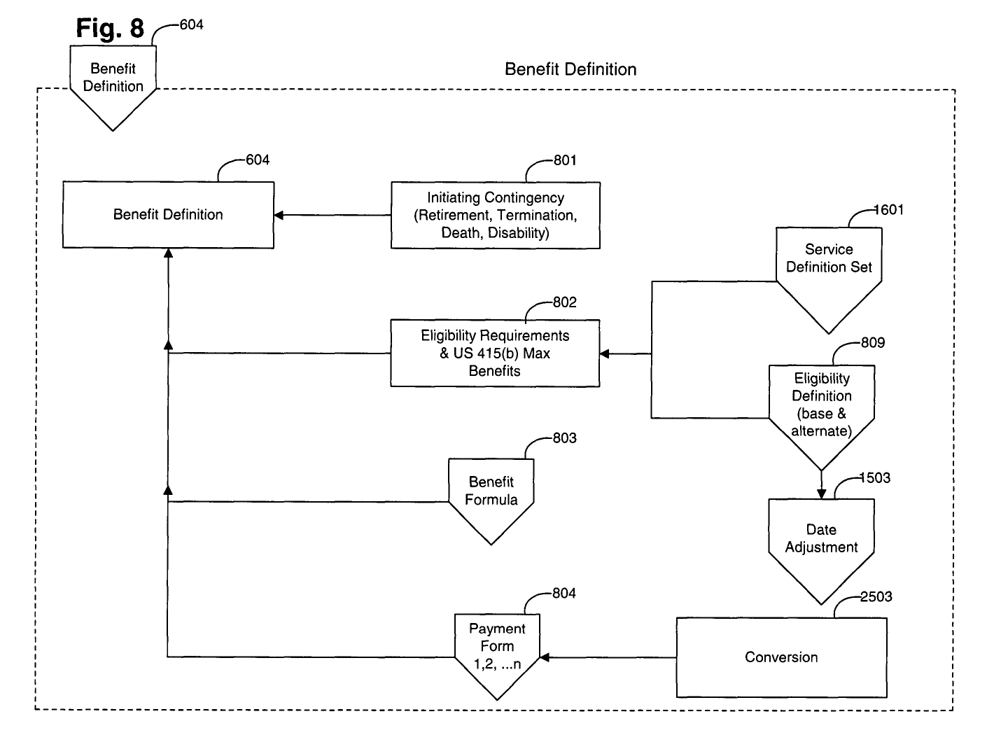

FIG. 6 is a block diagram showing exemplary elements included in, or used by, Plan Definition 503. Plan Definition 503 may include one or more of the following elements: Plan Attributes 601, Benefit Definitions object 604 (further detailed in FIG. 8), United States Maximum Benefit limit information object 605, Override Regulatory Data and EGTRRA (Economic Growth and Tax Relief Reconciliation Act of 2001) assumptions object 607, and user-defined Error and Warning Messages object 608.

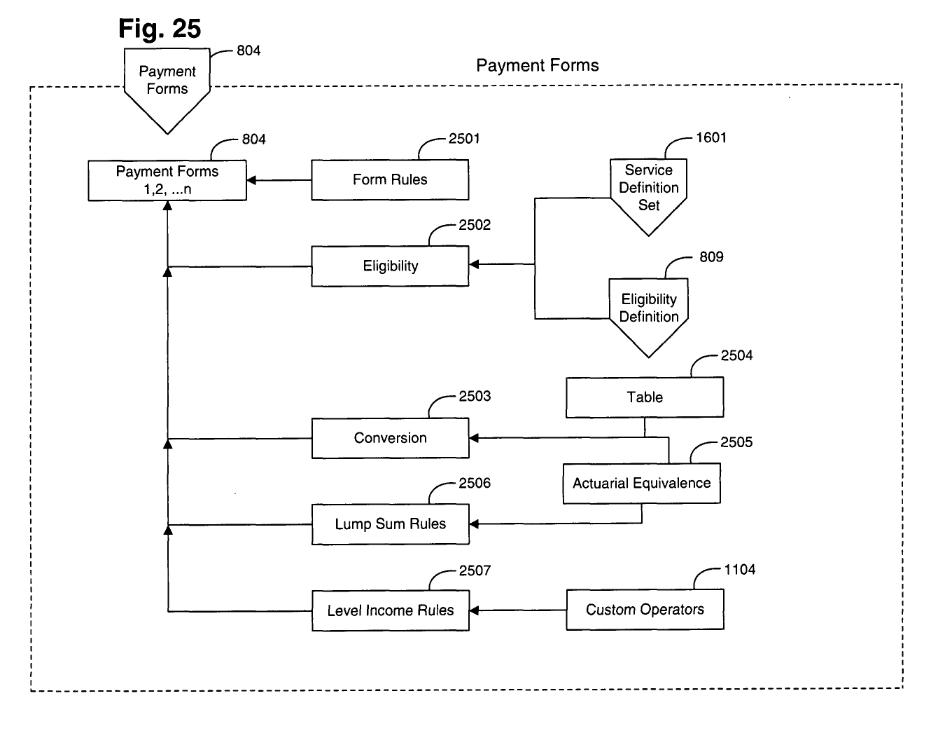

Plan Attributes 601 may establish general plan information 602 and general calculation rules 603 for calculation module 120. General plan information 602 may include the first month of the plan year, the standard assumption for actuarial equivalence, or the benefit payment timing and frequency. The first month of the plan year may be used to fix the calculation dates, which may be a user-requested date plus all plan years spanning those dates and beginning at hire. The standard assumption for actuarial equivalence may be a default basis for converting benefits to alternative payment forms (see FIG. 25 for more details on payment forms). DB plans may include an actuarial basis for converting a standard payment form to available optional payment forms. The DB plan lists the assumptions for mortality, interest, age setback or forward, and interpolation rules. Setting a default basis may allow these parameters to be set, while the user has the option of overriding this at the payment form level. The actuarial equivalence can be set according to each plan's definition and may be based on consultation with an actuary. A default basis could be an actuarial equivalence based on, for example, the 1971 Group Annuity Mortality Male table, an interest rate of 6%, and ages set back 3 years for beneficiaries and 3 years for secondary beneficiaries.

The benefit payment frequency and timing can serve at least two purposes: (1) to calculate payment form conversion factors; and (2) to round benefit amounts at the frequency chosen before being adjusted to annual amounts. For example, if the benefit payment frequency is monthly, the calculated benefits could be divided by 12 and rounded to the nearest cent.

General calculation rules 603 may establish rules for one or more of the following calculations: final average salary, maximum compensation limits, Social Security Primary Insurance Amount, Social Security Covered Compensation, and break-in-service rules. The final average salary may define the end of a considered period for the final average salary. Maximum compensation limits may, for example, indicate whether the 401(a)(17) Maximum Compensation Law Year is based on the calendar year of decrement or the calendar year in which the current plan year began. The Social Security Primary Insurance Amount and Covered Compensation rules may allow the Social Security Law Year and the rounding rules to be chosen. The Social Security Law Year can be used, for example, to calculate wage base, covered compensation, Primary Insurance Amount, or Yearly Maximum Pensionable Earnings. The rounding rules may apply to covered compensation and the average wage base. The break-in-service definition may determine if service is forfeited upon a break in employment. Benefit Definitions object 604 may establish one or more benefit contingencies available under a particular DB plan. FIG. 8 shows exemplary components of the Benefit Definitions object 604.

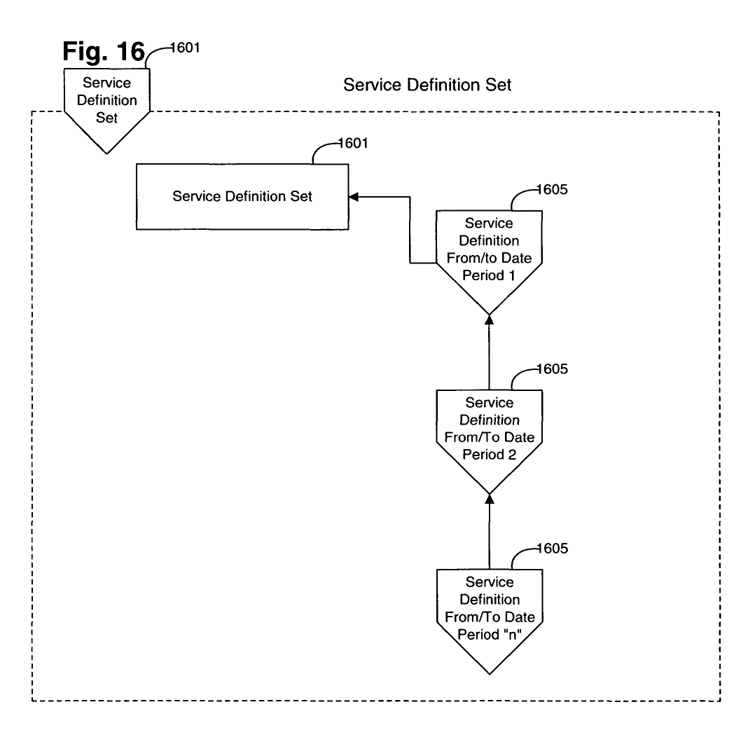

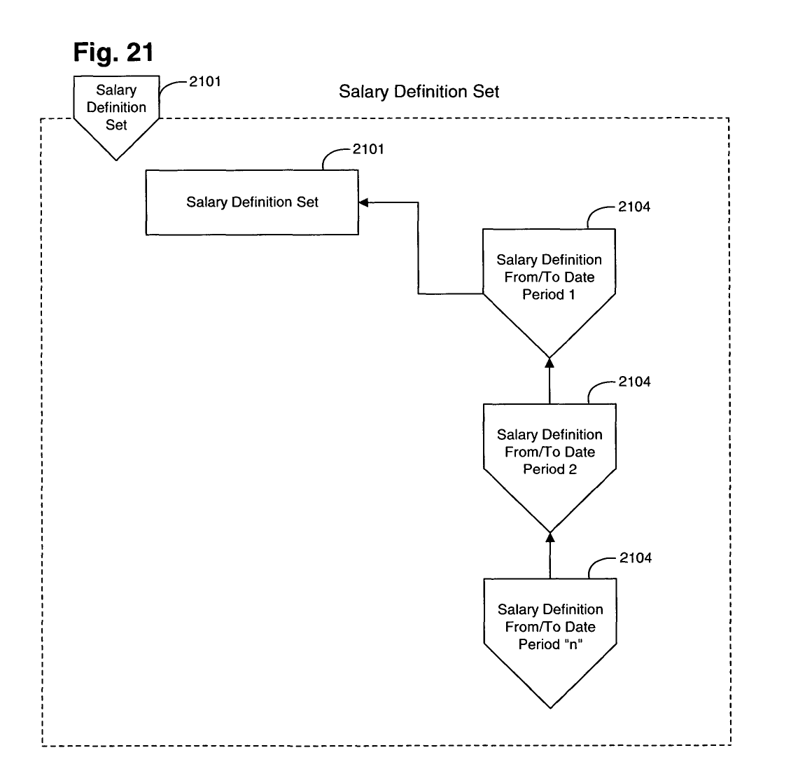

United States Maximum Benefits object 605 may specify or determine “a maximum allowable benefits” under Internal Revenue Code (IRC) Section 415(b), although Moreover, object 605 need not even be included in Plan Definition 503. Systems and methods consistent with the present invention are not limited to the IRC or even to US regulations. Object 605 can use any pertinent code or set of regulations to determine maximum allowable benefits. United States Maximum Benefits 605 could also use a mortality table (e.g., included in database 117), interest rates (also in database 117), rules 606, Service Definition Set 1601 (shown in detail in FIG. 16), and/or Salary Definition Set 2101 (shown in detail in FIG. 21). The mortality table, interest rates, and rules 606 may set values that convert the maximum benefits from those specified under the IRC to amounts payable early, late, and/or for forms of payment other than life annuity. The parameter for late payment may be changed to Social Security Normal Retirement Age if the Economic Growth and Tax Relief Reconciliation Act of 2001 indicator is not set. The Service Definition Set 1601 may determine the participation service for prorating the IRC Section 415(b) dollar limit. The Salary Definition Set 2101 may determine the highest three (3) year average salary limit.

Override regulatory data and EGTRRA object 607 may allow a user to override the Historical Regulatory Data and apply provisions of the Economic Growth and Tax Relief Reconciliation Act of 2001. The user can set override values or new entries to, for example, the historical data for U.S. Social Security Wage Base, U.S. Social Security Consumer Price Index, U.S. Social Security National Average Wage, Canada Yearly Maximum Pensionable Earnings, Maximum Benefit limit, and/or Maximum Compensation limit. For example, the user might override the Historical Regulatory Data if a particular DB plan adopted the optional ability to apply the EGTRRA maximum compensation limit retroactively. If indicated, the EGTRRA provisions can be applied to the maximum benefit and maximum compensation limits for benefit determination dates on or after the first day of the 2001 plan year. The provisions may alter the maximum benefit and maximum compensation limits as follows: the maximum benefit is reduced below age 62 or increased above age 65 and the post-2001 maximum compensation limit is indexed in $5,000 increments. As mentioned above, a skilled artisan will realize that Plan Definition 503 is not limited to United States regulations or Acts. Systems and methods consistent with the invention can use object 607 in conjunction with any type of regulatory data, and need not be present in the Plan Definition 503.

Error and warning messages object 608 may establish user-specified conditions to be tested with the executed plan benefits, although calculation module 120 may perform its own internal error and warning checks. Error conditions may stop calculation processing and return a message, while warning conditions may allow calculation processing to continue and return a notification. Errors and warnings can be set by the user and may be unique to each DB plan. For example, Plan A might require review of all benefit calculations involving benefits larger than $20,000. For such a plan, a condition may be set for checking benefits exceeding $20,000; and, upon such a condition being triggered, the following warning message could be returned (although calculation may continue): “calculation needs to be reviewed.”

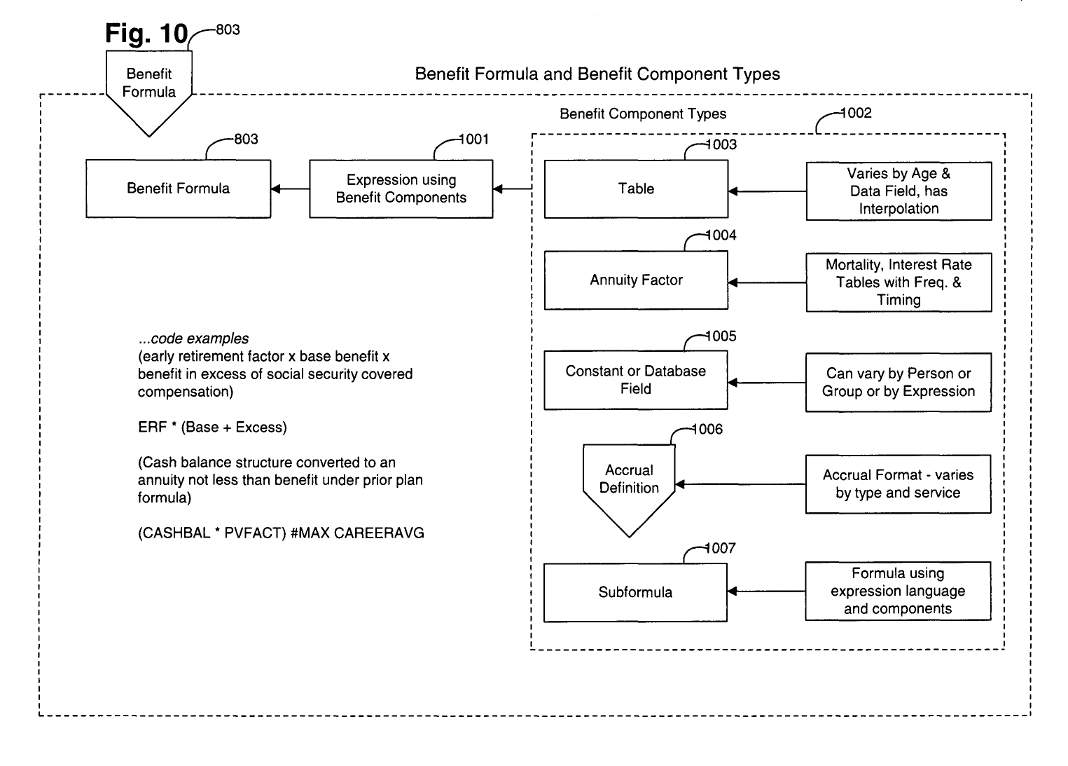

FIG. 8 is a block diagram showing exemplary objects that may be included in Benefit Definition 604. As illustrated, Benefit Definition 604 may comprise one or more of the following: initiating contingencies object 801, eligibility requirements object 802, benefit formula object 803 (detailed in FIG. 10), and/or payment forms object 804 (detailed in FIG. 25).

Initiating contingencies object 801 may specify one or more events that trigger availability of a particular benefit to a beneficiary. For example, the benefit definitions 604 may be available for one or more of the following triggering events: disability, death, retirement, and/or termination. The disability contingency may be used when a particular DB plan provides disability benefits to beneficiaries that differ from those benefits provided upon termination or retirement without disability. A death contingency may specify rules and provisions governing benefits offered when a beneficiary's death occurs while employed and/or is a result of a work-related event. The retirement contingency may be used to identify benefits payable when the beneficiary retires from active employment. The termination contingency may be used to specify benefits available upon termination of employment and prior to retirement benefit eligibility. The ability to specify different Benefit Definitions 604 based on varying initiating contingencies object 801 facilitates the handling of a variety of benefits offered under any given DB plan.

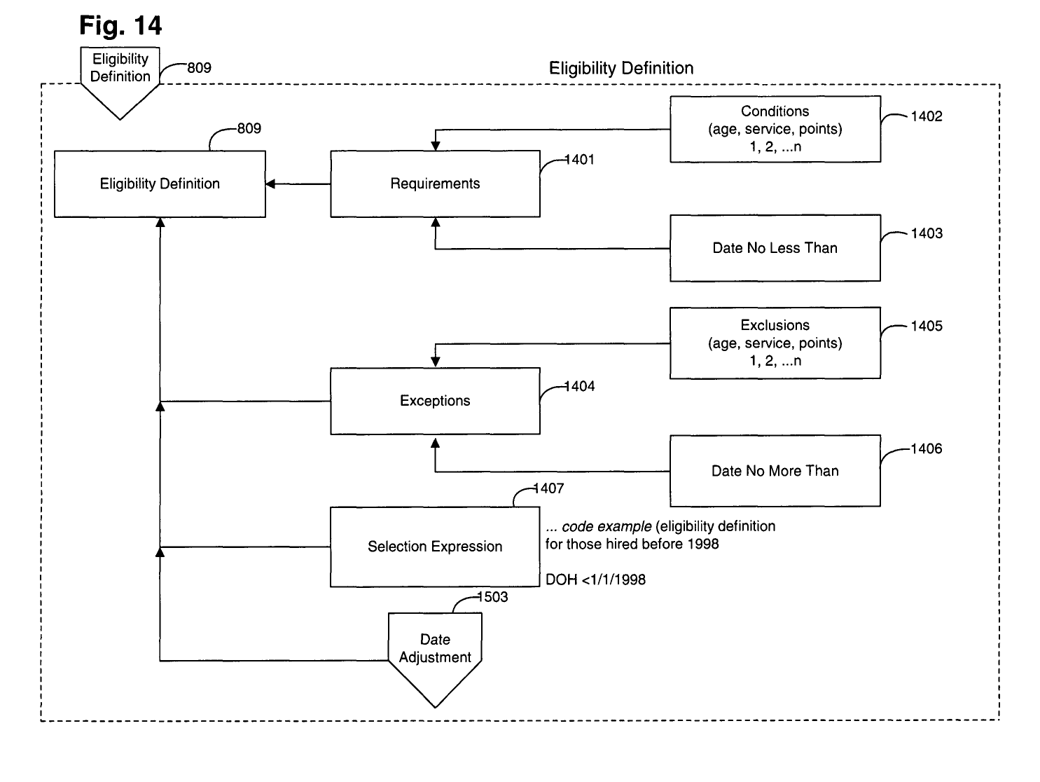

Eligibility requirements object 802 may specify eligibility conditions that a beneficiary must meet to receive to the corresponding Benefit Definition 604 and may indicate whether maximum benefit rules from IRC § 415(b) should apply. Eligibility requirements may include age and service requirements (e.g., age 55 with 10 years of service, but may be more elaborate with multiple alternative requirements or location/division limitations. Consistent with principles of the present invention, eligibility requirements may be parameterized, allowing a user to reference an eligibility (base and alternative) definition 809 (detailed in FIG. 14) and accompanying Service Definition Set 1601 (detailed in FIG. 16).

The Eligibility Definition 809 may contain rules, based on age, service, points (i.e., age plus service) and/or data, which a beneficiary must meet, including any applicable date adjustment 1503. For example, a participant meeting the age 55 and 10 years of service requirement on February 17^{th} may not be eligible for the benefit until March 1^{st} (the first of the month coincident with or following attainment of eligibility). The Service Definition Set 1601 can be used to calculate a service component of the Eligibility Definition 809. Consistent with principles of the present invention, a plurality of different criteria may be established and specified, each of which can be evaluated by calculation module 120 to determine if the beneficiary is entitled to a Benefit Definition 604. For example, if a DB plan's eligibility criteria involves two types of service (e.g., vesting service and participation service), two different and corresponding criteria can be set to determine eligibility.

As mentioned above, eligibility requirements object 802 may indicate whether maximum benefit rules from IRC § 415(b) should be applied to the benefit definition 604, because IRC § 415(b) limits the annual benefit under a tax qualified DB plan. As above, however, any code or regulation may be used in place of the IRC and maximum benefit rules may not apply.

Benefit formula 803 may create and/or specify one or more formulae for determining benefits payable under a particular DB plan. Such formulae may be built using the expression language (or user-defined components) maintained in repository 125.

In one example, a formula of 1.5% of final average earnings per year of service reduced for early commencement might be parameterized as “Erf* Bft,” where Erf is a table-type component referencing an age-based table of early retirement reduction factors, and where Bft is an accrual definition-type component that incorporates both the 1.5% accrual rate and the final average earnings “basis.” Additional details of benefit formula 803 are discussed below in connection with FIG. 10.

Payment form 804 may establish and/or specify one or more different payment forms to be associated with benefit definition 604. Payment forms may be of one or more of the following types: life annuity, joint life annuity, years certain, years certain and life, years certain and joint life, lump sum, Social Security level income, and joint life Social Security level income. The life annuity payment form may allow for level payments for the beneficiary's lifetime. Joint-life annuity forms of payment may allow for level payments for the beneficiary's lifetime and payments continuing for the lifetime of a joint annuitant. The “years certain” form of payment can provide payments that are guaranteed for a specific number of years, where the payments are made to a named beneficiary if the beneficiary dies before the end of the certain period. The “years certain and life” payment form may allow for payments that are guaranteed for a specific number of years and then continue for the beneficiary's lifetime, the payments being directed to a named beneficiary if the beneficiary dies before the end of the certain period. The “years certain and joint-life” payment form may allow for payments that are guaranteed for a specific number of years and then continue for the beneficiary's and joint annuitant's lifetime; if the beneficiary dies before the end of the certain period the payments are made to a named beneficiary. Social Security level income payment forms may pay a higher benefit prior to the assumed commencement of Social Security benefits and a lower amount thereafter so as to offer the beneficiary a level retirement income over the total period.

Conversion object 2503, shown in FIG. 8 (and detailed further in FIG. 25), may create rules that calculation module 120 can use to calculate conversion factors for a particular payment form 804. Consistent with principles of the present invention, a system plan can use actuarial equivalence, conversion tables, or specify that no conversion is required. Actuarial equivalence may use mortality and interest rates to calculate factors that produce benefits of an equal value to the normal form of payment. Conversion tables may allow a user to setup a table of factors that produce benefits of an equal value to the normal form of payment. Additional details of the payment form 804 object are presented below in connection with FIG. 25.

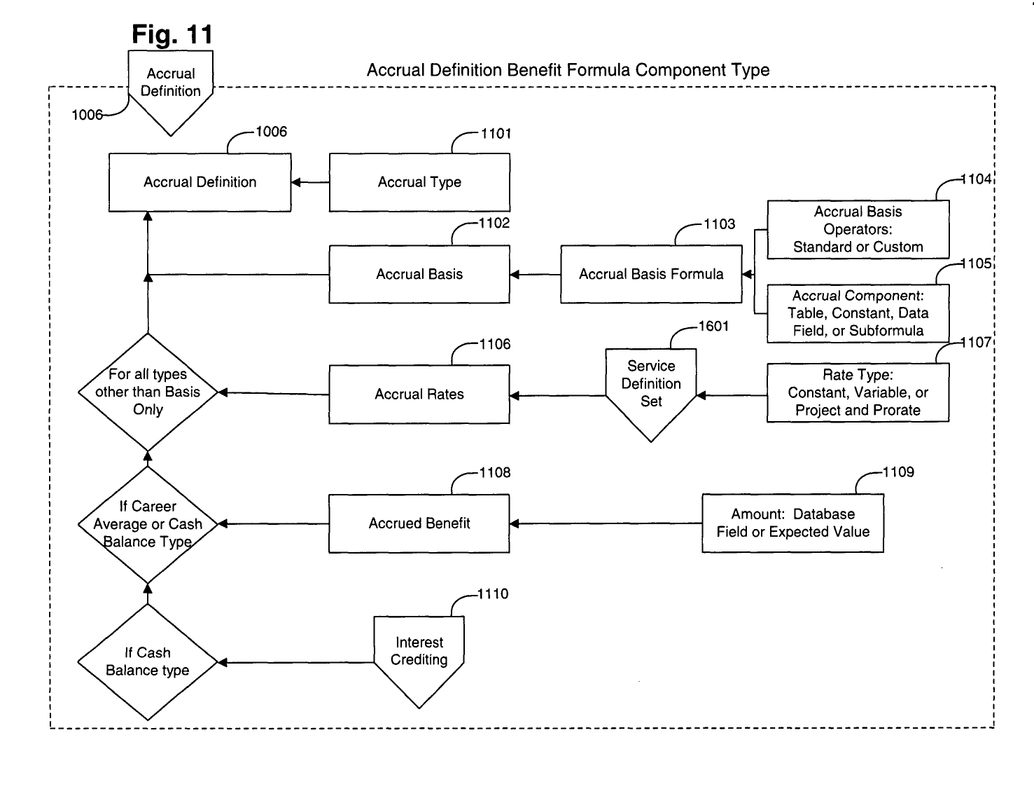

FIG. 10 is a block diagram summarizing an exemplary construction of benefit formula 803. As explained above, the benefit formula 803 object may be developed using the expression language and benefit component types 1002. Benefit component types may include one or more of the following: a table 1003, an annuity factor 1004, a constant or database field 1005, and accrual definition 1006 (detailed further in FIG. 11), or a subformula 1007. The use of the “expression language” enables formulae to be easily understood. Table 1 of FIG. 9 summarizes exemplary built-in expression operators. Table 2 of FIG. 12 summarizes exemplary accrual basis operators. The use of such expression language, and the ability to define the different types of components, may allow a user without any knowledge of computer programming languages to easily and logically build benefit structures for a DB plan.

A DB plan may include a legal document that details all of the rules and formulas pertaining to a beneficiary's entitlement to benefits. The structure and wording of such a document may vary with each DB plan. The following is an example retirement benefit formula for a DB plan:

“A beneficiary 's accrued benefit at his normal retirement date shall equal:

(A) 1.2% of the beneficiary's final average compensation not in excess of $7,800, multiplied by his years of benefit service plus

(B) 0.65% of the beneficiary's final average compensation in excess of $7,800, multiplied by his years of benefit service not in excess of 35 years.”

This formula might be parameterized as:

BaseBen+ExcessBen

where BaseBen and ExcessBen are accrual definition 1006 types of benefit components 1002 that are parameterized to calculate items A and B above, respectively.

Consistent with principles of the present invention, a table 1003 component may access a user-created table that could be based on age, beneficiary age, sex and/or service. DB plan early retirement reduction factors can be age-based (e.g., a 3% reduction for each year that retirement precedes age 65), or use some other criteria. To implement an age-based factor, users can incorporate a benefit formula in a table with the value of 1 at age 65, 0.97 at 64, 0.94 at 63, etc., and then reference that table through a table 1003 type benefit formula component. Other issues to consider might include: whether the component references a single table for all calculations or one that varies based on a database field; a table that contains the values for the component; a Service Definition Set 1601 to calculate the service referenced in a table; or age determination and interpolation rules. Age determination and interpolation rules may allow a user to control age calculation and table access (when, for example, the beneficiary's age is not an integer). The user may determine age as nearest age (an integer), age at last birthday age, or as some other age appropriate to the implementation. If last birthday age is chosen, the table values may be interpolated based on the beneficiary's actual age in years and months.

The annuity factor 1004, shown in FIG. 10, may include one or more of the following properties: mortality rate(s), interest rate(s), payment form parameters, payment frequency, and payment timing. These properties may serve as rules that calculation module 120 evaluates when calculating an annuity factor. The mortality rate may be a table of mortality probabilities; the interest rate may be a fixed rate or a variable rate from a (possibly adjusted) historical interest rate table (e.g., in information database 117). The payment form parameters may govern the annuity form, joint life parameters, and age calculation and interpolation. Age interpolation rules can allow a user to control age calculation and calculation of the component value. The user can set the age calculation to be “nearest age” or “last birthday age.” One use of the annuity factor 1004 component type may be to convert cash balance accounts (which are lump sum values) to annuity payments, to facilitate comparison with grandfathered traditional DB formula values.

The constant or database field component 1005 may generate a value that is a constant number, a numeric field from the census data, and/or a defined expression from one or more census data fields. A constant number can be a single amount for all beneficiaries or an amount that varies based on another field in the data dictionary (such as location). Component 1005 may reference a preset amount included in data submitted in a calculation request (e.g., request 101). A numeric value may be generated for this component using the expression language shown in Table 1 of FIG. 9. Component 1005 could be used for plans that employ benefit formulas based on a flat dollar amount multiplied by beneficiary service (where the flat dollar amount varies by job classification). This situation could also be handled by setting a constant that varies by a data dictionary field containing job classification.

The accrual definition component 1006 may specify rules that allow calculation module 120 to determine benefit accruals for DB formulas accruing with service. DB plans can reference this type of component in their benefit formulas. Certain implementations consistent with the present invention may use distinct types of accrual definitions corresponding to generic types of DB formulae. Examples of such definition types include final average, career average or cash balance. Further, an additional definition type could allow a user to access certain built-in system operators, such as Social Security Primary Insurance Amount and Final Salary, without a service adjustment. Accrual definitions are discussed in more detail below in connection with FIG. 11.

The subformula component type 1007 may be created using the user-defined benefit components and the expression language (see Table 1 of FIG. 9). The subformula 1007 may be a convenient way to isolate specific complex aspects of a plan that may be referenced multiple times or that a user may wish to have available directly for output.

FIG. 11 is a block diagram depicting exemplary elements that may be included in the accrual definition object 1006. Accrual definition object 1006 may be designed to construct pension benefits that grow with service. As mentioned above, different types of accrual definitions may correspond to different generic types of pension formulas (e.g., final average, career average and cash balance).

Another type of accrual definition (basis only) may allow a user to access certain built-in system operators, known as accrual basis operators, that calculate pay, Social Security Covered Compensation, Social Security Primary Insurance Amount, etc. These accrual basis operators can be accessed through the accrual basis object 1102 and are summarized in Table 2 of FIG. 12.

A final average accrual may be used by a formula that determines the total benefit rate based on all years of service and then multiplies it by the appropriate value, for example, the beneficiary's final 5-year average earnings at retirement. For instance, a plan may grant 1.5% of final average pay for each year of service up to 30. In such a case, the annual payable pension for a beneficiary retiring with 35 years of service would be the maximum accrual of 45% multiplied by his final average pay.

A career average accrual may be used by a formula that builds the benefit yearly based on service and salary. For instance, a plan may grant 1% of salary for each year of service up to 15 and 1.5% of salary for each year of service in excess of 15. A cash balance accrual may be similar to a career average accrual in that the benefit could be built yearly based on service and salary; but a cash balance accrual also might also include interest. A cash balance accrual may be comparable to a defined contribution or 401(k) plan where each year the beneficiary's balance grows with that year's accrual/contribution plus interest on prior year accruals/contributions.

As FIG. 11 shows, an accrual definition 1006 may include an accrual type an accrual basis 1102, accrual rates 1106 (except for basis-only accruals), an accrued benefit 1108 (e.g., for career average or cash balance types), and an interest crediting 1110 (e.g., for cash balance type). The accrual type 1101 object may select one of the following exemplary types of accrual definitions 1006: final average, career average, cash balance, or basis only.

The final average type accrual definition may calculate a cumulative sum of accrual rates 1106 over a beneficiary's service until decrement. This sum may then be multiplied by an accrual basis value 1102, also evaluated at the decrement date. In certain final average pay plans, the percentages of final average salary may be entered in the accrual rates 1106, and the final average salary itself may be entered in the accrual basis 1102. For example, if the beneficiary's accrued benefit equals 1.2% of the final average compensation multiplied by his years of service, the accrual basis 1102 would reference the final average salary operator from Table 2 (FIG. 12) and the accrual rates 1106 would reference a Service Definition Set 1601 (detailed in FIG. 16) and the constant rate of 0.012.

Career average accrual definitions may calculate a running total until decrement date, each term of which is a given year's rate multiplied by its basis. For certain career-average DB plans, the percentages can be entered in the accrual rates 1106 and the salary can be entered in the accrual basis 1102. The accrued benefit component 1108 may identify the benefit used as the beginning point for the accruals. For example, if the beneficiary's accrued benefit equals 2% of salary per year of service, the accrual basis 1102 would reference the salary operator from Table 2 (FIG. 12), and the accrual rates 1106 would reference a Service Definition Set 1601 and the constant rate of 0.02. The accrued benefit 1108 may in turn reference a census data field containing the benefit to be used as the beginning point for the accruals. If the accrued benefit vests as of Dec. 31, 2000, this new value may be added to accruals calculated from Jan. 1, 2001 through the decrement date.

Cash balance accrual definitions may work similarly to the career average type, where a cumulative total of each year's rate multiplied by its basis is calculated. The percentages may be entered in the accrual rates 1106 and the salary may be entered in the accrual basis 1102. The accrued benefit component 1108 may identify an account balance (with interest) as the beginning point for the accruals. In addition, cash balance plans can credit interest on such an account. Interest crediting parameters can be set up via the interest-crediting object 1110. For example, if the beneficiary's cash balance account is determined as a benefit credit of 5% of the yearly salary (where 1,000 hours of service are earned) and interest credits of 5.5% per year on the account balance, then the accrual basis 1102 would reference the salary operator from Table 2 (FIG. 12), and the accrual rates 1106 would reference a Service Definition Set 1601 and the constant rate of 0.05. The accrued benefit 1108 could reference the census data field that begins the accruals, and the interest crediting 1110 could reference a flat rate of 0.055 per year, or, if appropriate, an interest rate table based on adjusted historical interest rates. If the accrued benefit is as of Dec. 31, 2000, cash balance benefit credit accruals and interest credit from Jan. 1, 2001 through the decrement date can be calculated. Employee contribution plans could also utilize the cash balance accrual definitions.

The “basis only” accrual definitions may allow a user to reference the accrual basis operators (see Table 2). These operators refer to pay, covered compensation, and/or Social Security through the accrual basis object 1102.

The accrual basis 1102 may be constructed using an accrual basis formula 1103, accrual basis operators 1104 and, optionally, accrual basis components 1105. The accrual basis formula 1103 includes one or more numbers, accrual basis operators 1104, accrual basis components 1105, and/or expression operators (e.g., from Table 1). In certain implementations consistent with the present invention, the accrual basis 1102 may be required in all accrual definitions. In the examples given above, the accrual basis was simply a final average salary or salary operator, but more complex formulas referencing tables and/or database fields (i.e., accrual components 1105) could also be developed. For example, an accrual basis formula can be constructed which references a different basis depending on job classification.

The accrual basis operators 1104 can be either standard (as shown in Table 2 of FIG. 12) or custom. For example, if a user wishes to reference the Social Security Taxable Wage Base in an accrual basis formula 1103, the user may employ the standard operator #SSWB. In one embodiment, the custom accrual basis operators can be user-defined variations on the accrual basis components shown in Table 2. For example, the standard final average salary operator (n #FAS m) may calculate final average salary as the average of the n highest consecutive annual salaries out of the last m annual salaries. By contrast, the custom operators may include options such as the ability to calculate a monthly final average and use non-consecutive earnings. The creation of custom operators may allow for a virtually unlimited variety of assumptions that easily capture the complexities of varying DB plans.

Possible accrual-basis components 1105 maybe tables, constants, database fields and subformulas. The “table” type may access one or more user-created tables, which may be age-based, beneficiary age-based, sex-based and/or service-based. A single table for all beneficiaries may be used or a plurality of tables may be used and selected based on a database field. Tables may, for example, be used in accrual basis for age-based changes in accrual rates. The constant accrual basis component type can be either a constant value for all beneficiaries or an amount that varies by beneficiary based on a field in the data dictionary. The database field accrual basis component type may reference a set amount included the data submitted in a calculation request (e.g., 101). The subformula accrual basis component type may be created using, for example, the user-defined accrual components and the expression language shown in Table 1 of FIG. 9.

Accrual rates 1106 may be required for all types of accrual definitions except those that are designated as “basis only.” The user can specify whether accruals are based on, for example, service (default), age, and/or points (age plus service). The accrual rates 1106 object may comprise the Service Definition Set 1601 and a rate type 1107. The Service Definition Set 1601 (detailed in FIG. 16) may indicate how much service the beneficiary accrues in each plan year. The amount of service could then determine the accrual rate for a plan year in that (1) the accrual rates may be defined to vary by years of service (i.e., 1% for up to 5 years of service, 2% for service over 5 years), (2) the full potential accrual rate for a plan year may be parameterized to require that a full year of service be earned in that plan year (otherwise the accrual is proportional to the amount of service earned), and (3) if there is no service earned in a plan year then the accrual rate may be defined to be 0 for that plan year.

The rate type 1107 may specify one of three distinct accrual methods: constant, variable, or project and prorate. The “constant” method is the simplest structure: a constant rate for each year of service. For example, if a beneficiary's accrued benefit equals 1.2% of his final average compensation multiplied by his years of benefit service, the accrual rates 1106 could reference the Service Definition Set 1601 to define service for the accrual, a constant rate type (1107), and 0.012 as the rate amount.

The variable rate type (1107) structure may facilitate rates that differ by amounts of service accrued, perhaps including service caps. This structure could also enable rates to be defined using age or points (age +service). The variable rate structure may also allow rates that vary by calendar year. An example of a service cap can be found in a formula specifying that a beneficiary's accrued benefit equals 1.2% of his final average compensation multiplied by his years of benefit service not in excess of 35 years. In such a case, the accrual rates 1106 could reference the Service Definition Set 1601 to define service for the accrual; a rate type 1107 of, for example, “varies by years of service;” and 0.012 as the rate amount for the first 35 years of service with 0 as the rate amount for service in excess of 35 years.

The project and prorate rate type (1107) can be used for plans where the ultimate accrual is known (e.g., 50%) but the accrual pattern varies by individual because the ultimate accrual is earned over the period from, say, entry age to age 65. In this example, the accrual percentage at age 55 would be 25% for a beneficiary hired at age 45, but 33.33% for a beneficiary hired at age 35. Another example of a project and prorate method is:

“a beneficiary 's accrued benefit shall equal 42% of his final average compensation multiplied by a ratio of his years of benefit service not in excess of 35 years at his separation of service over the greater of the service he would have earned as of his 65 birthday or 35.”

To parameterize the above example, the accrual rates 1106 would reference a Service Definition Set 1601 to define service for the accrual, a rate type 1107 of “project and prorate,” 0.42 as the ultimate accrual, 65 as the projection age, and 35 as the service requirement.

The accrued benefit 1108 may be required for career average and cash balance accrual definition types 1101. Since both of these accrual types can build a benefit up year-by-year, they may communicate that benefit to the beneficiary and, once communicated, be considered final. To ensure such finality, the communicated accrued benefit may be set as the starting point, with future accruals being applied as defined per the accrual basis 1102 and accrual rates 1106.

The accrued benefit 1108 may be specified in any appropriate manner, such as either a database field or an expected value (i.e., the value the invention calculates based on the accrual basis 1102, accrual rates 1106 and prior service per the Service Definition Set 1601). The database field selection could provide both the accrued benefit and the effective date thereof and may be part of the data supplied through a calculation request (e.g., 101). If the accrued benefit 1108 is set as a database field, an additional condition may be established to set the empirical benefit value to zero. This option could be used if a calculation involves components but the benefit is stored as one value; this setting avoids double counting of the account balance. The expected value option may be used when the accrued benefit is not available through the data and needs to be generated by the calculation module 120. If this option is chosen, the calculation module 120 may generate a sequence of expected accrued benefits from the date of hire through the most recent plan year-end. For career average types, the accrued benefit may contain an accrued benefit for cash balance accruals, and the accrued benefit may contain an account balance with interest.

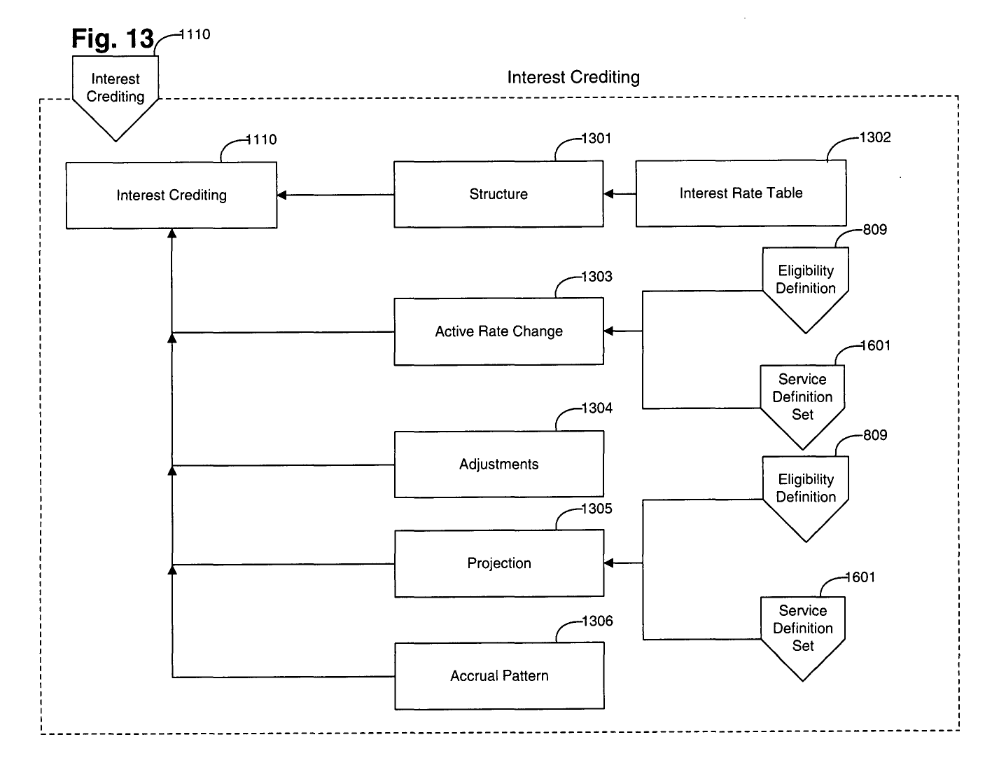

Interest crediting 1110 may be required for cash balance accrual types 1101. Interest crediting 1110 could define the rules for calculating the interest accruals for the accrual definition 1006. These rules may, for example, include the structure of the interest rate, historically set fixed rates, minimum and maximum rates, and/or projections of the interest rate. Interest crediting 1110 is discussed in detail below in connection with FIG. 13.

FIG. 13 is a block diagram showing elements which may be included in the interest crediting object 1110. As illustrated, object 1110 may comprise a structure object 1301, an active rate change object 1303, adjustments object 1304, a projection object 1305, and an accrual pattern object 1306.

The structure object 1301 may describe the basic structure of interest crediting for a cash balance accrual definition 1006. The rules in structure object 1301 may include, for example, the type of rate (constant or variable based on market rates), crediting frequency, a methodology for determining the crediting period rate if more frequent than annual, and one or more rounding rules. If the type of rate is variable the structure object 1301 may include and/or utilize an interest rate table 1302. Interest rate table 1302 may use an existing historical index and allow users to adjust the rates from the historical interest rate table and set the parameters that determine the beginning rate. Consistent with principles of the present invention, users may update the historical interest rate table, and the system may dynamically build all of the potential combinations that the DB plan requires. For example, a plan's actuarial equivalence for lump sum payments may be based on the 30-year Treasury Rate effective as of the November 1 preceding the calendar year that the member terminates, and the cash balance crediting rate may be based on the 30-year Treasury Rate effective as of the November 1 preceding the calendar year plus 150 basis points. Instead of carrying two tables that need to be updated, the user may update one base table and, using the base table as a starting point, the system may build a table of rates.

In exemplary embodiments of the present invention, a user may create a table of rates by averaging existing rates in a base table, adding basis points, multiplying by a percentage, and applying rounding rules.

Determining the starting rate may be accomplished through setting stability and look back periods. A stability period may determine how long the rate is in effect and may be set to: a year starting with a certain month, a quarter starting with a certain month, or a month. A look back period may reflect the number of months back from the start of the stability period and may be used to select the beginning rate. For example, if the plan states that the rate is the 30 year Treasury Rate published in November and is static for a calendar year, the user could set the stability period to a year starting in January and the look back period to two (2) months. Systems of the present invention may then check the rates and select the appropriate rate.

The calculation module 120 may handle constant rates or rates based on a table. A “constant” rate does not change and may, for example, include a 5% rate applied to employee contributions. An interest rate table could enable parameters to be set that can access adjusted historical interest rates. For example, the cash balance interest credits may be based on a 12-month average, ending with the November prior to the beginning of the plan year, of 30-Year Treasury Constant Maturities. Additional details of interest rate tables are discussed below.

Rounding rules can be specified to round crediting rates for crediting annually or more frequently. Rounding of the annual crediting rate may be handled in an interest rate table. The rounding rule may include both the amount and direction of rounding. “Amount” refers the quantity to which the rate should be rounded. For example, an amount of 0.0025 indicates that rates should be rounded to, based on the direction, 25 basis points. “Direction” specifies whether the interest rate should be rounded, for example, up, down, or nearest. If the direction is “up,” the interest rate may be rounded to the next highest multiple. The “down” direction rounds the interest rate to the next lowest multiple, and “nearest” rounds to the closest multiple of the rounding rule amount.

The adjustments object 1304 may specify the rules that control overrides for certain periods of time as well as minimum and maximum interest rates. The override for certain periods may apply a constant rate superseding the rules set in structure object 1301. For example, a plan that converts from a traditional DB formula to a cash balance formula effective Jan. 1, 2001, may specify at the point of conversion that the account balance will be credited with interest at the rate of 6% for the first two years, and, effective Jan. 1, 2003, change to a rate based on 30-year Treasuries. In this case, the override could be set to credit a flat rate of 6% from Jan. 1, 2001 through Dec. 31, 2002.

The minimum interest rate may establish a floor below which the crediting rate cannot fall, and the maximum interest rate may set a ceiling above which the crediting rate cannot exceed. Both the minimum and maximum crediting rates can be specified as either a constant rate or an interest rate table. A constant rate does not change over time such as a minimum crediting rate of 4%. The interest rate table could allow parameters to be set that access adjusted historical interest rate tables, such as 120% of the average One-Year-Treasury Constant Maturities for the month of October preceding the beginning of the Plan Year.

Active rate change object 1303 can allow a user to change the crediting rate upon the beneficiary's attainment of a specified eligibility requirement, such as reaching age 60. Active rate change 1303 may reference Eligibility Definition 809 (detailed in FIG. 14 below) and Service Definition Set 1601 to define the conditions under which the crediting rate will change from what is specified in the structure 1301 object to a different amount. The active rate change may enable a new crediting rate to be set to either a constant rate or a value based on an interest rate table when the beneficiary satisfies the specified eligibility criteria.

The Eligibility Definition object 809 may establish conditions for the crediting rate to change. Such conditions may be based on age, service, points and/or data. An age requirement may specify that the beneficiary be at least this age for the condition to be met. The service requirement may specify that the beneficiary have been employed for a certain number of years. The points requirement may specify that the beneficiary's age and service must sum to at least a given number. The Service Definition Set 1601 may be used to calculate the service component of the eligibility definition object 809.

For example, in a plan using the active rate change 1303 features, interest credits may be at 3% from date of employment until the beneficiary has been employed for 1 full year and at 5% thereafter. To parameterize such a plan, a user could create an Eligibility Definition 809 with a requirement of 1 year of service and pair it with a Service Definition Set 1601 that calculates service based on an elapsed time basis starting at date of employment. These objects may be referenced in the rules of active rate change 1303 along with a change to a constant rate of 5%, where the crediting rate referenced in the structure object 1301 is 3%.

The projection object 1305 may specify how interest crediting should apply during the period after a beneficiary terminates employment and prior to commencement or distribution of benefits. This parameter may be required where, for example, a law (e.g., U.S. Pension Law) specifies that the annual pension accrual in a cash balance plan be defined to include interest credits through the plan's Normal Retirement Age. Consistent with principles of the present invention, a user may specify either that interest credits will continue in a regular fashion (i.e., interest will be credited in each future crediting period at a specified rate) or that the cash balance should be adjusted to include a full projection of interest through a specified period such as to Normal Retirement Age. If interest credits simply continue, the user can specify whether this post-decrement crediting rate is a new constant rate or a continuation of the plan's basic crediting rate per structure 1301, adjustments 1304 and active rate change 1303.

If interest is projected, the user can specify the projection date as an eligibility definition object 810 and a Service Definition Set 1601. The eligibility definition object 810 may set the conditions that determine the future date to which the account balance is projected. The conditions set in an eligibility definition object 810 may, for example, be based on age, service, points and/or data. The age requirement may specify that the beneficiary be at least a given age for the condition to be met. The service requirement may specify that the beneficiary be employed for a certain number of years. The points requirement may specify that the beneficiary's age and service must sum to at least the number of points. The Service Definition Set 1601 can be used to calculate the service component of the eligibility definition object 809. The data-based requirement may create eligibility criteria dependent on the beneficiary's data. For example, the eligibility criteria for the projection of interest could be that the beneficiary was not classified as a salaried employee. In this case, the eligibility definition would reference the field that contains the employee classification.

When interest is projected, the user may also need to specify the interest rate for the projection. The rate could be, for example, the last known rate, a constant rate, or a rate from an interest rate table. The last known rate selection may use a rate determined from parameters in structure object 1301, adjustments object 1304 or active rate change object 1303 to project the account balance with interest until a projection date. If the constant rate selection is chosen, the rate may be constant from the decrement date to the projection date. If the interest rate table selection is chosen, parameters may be set which adjust an historical interest rate table.

Accrual Pattern object 1306 may allow the default treatment of accrual patterns for cash balance plans to be overridden. This feature could be used to parse accrual for crediting periods more frequently than annually. For example, if crediting is quarterly, the annual accrual (e.g., salary during the year) can be parsed into the amount reported for each quarter. The user may, however, need to override this approach to handle application of maximum compensation limits in accordance with plan provisions. Another use of overriding default treatment accrual patterns may be to discount current plan year accruals from the end of the crediting period to the calculation date at the current crediting rate. For a DB plan that credits annually, this may be mathematically equivalent to not crediting the accrual until the end of the plan year.

FIG. 14 is a block diagram showing the Eligibility Definition 809 objects that may used to define eligibility for various pension plan attributes. As illustrated in FIG. 14, Eligibility Definition 809 may include eligibility Requirements 1401, Exceptions 1404, a Selection Expression 1407, and a Date Adjustment 1503. Sample code for a Selection Expression 1407 is depicted in FIG. 14. Eligibility Definitions 809 may be referenced frequently throughout the system because eligibility may be a primary consideration in DB plans. The eligibility concept may be used for defining eligibility for benefits, alternative forms of payment, an alternative cash balance crediting rate, to begin benefit accruals, etc.

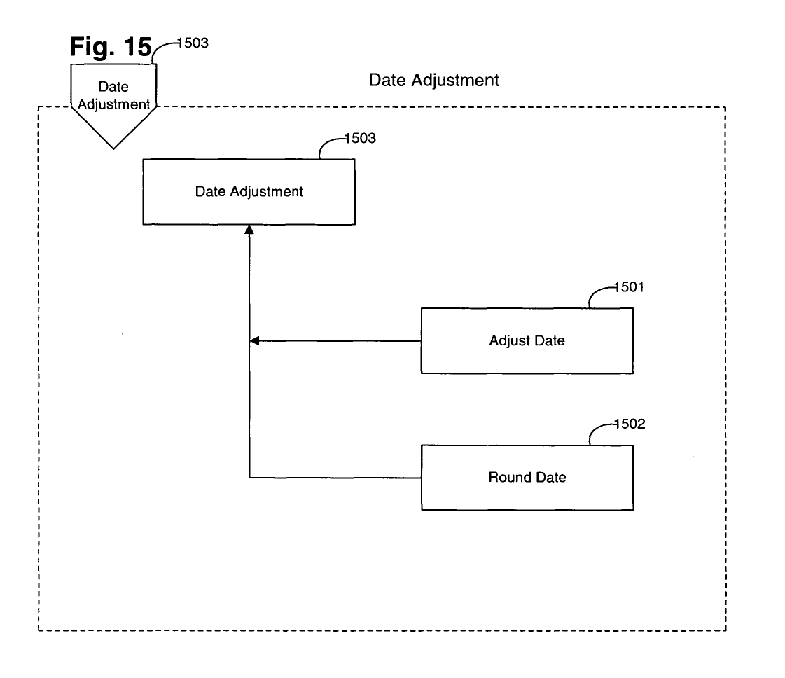

Eligibility definitions object 809 may specify and/or indicate when a participant becomes eligible (through the requirements object 1401 and selection expression object 1407) and when, if ever, the participant ceases to be eligible (through the exceptions 1404). The date adjustment object 1503 (see FIG. 15) can refine the exact date that eligibility commences and/or ceases.

As illustrated in FIG. 14, eligibility Requirements object 1401 may include conditions object 1402 and “date no less than” object 1403. Eligibility Exceptions object 1404 may include exclusions object 1405 and “date no more than” object 1406. The conditions object 1402 may be composed of criteria relative to the beneficiary's age, beneficiary's service, or the beneficiary's points, where points are the sum of the beneficiary's age and service. Conditions can be a combination of required criteria (e.g., age 65 with 5 years of service) and alternative criteria (e.g., age 55 with 10 years of service or age 65). Requirement conditions with exception conditions can be used for retirement eligibility in a situation where the beneficiary was eligible at age 55, but became ineligible upon attainment of 30 years of service because a different benefit structure was then payable

An example of an age- and service-based condition may include an eligibility condition requiring attainment of 21 years of age and 1 year of employment for DB plan participation. Calculation module 120 may calculate the date that a beneficiary attains 21 years of age and the date upon which the beneficiary has been employed for one year. It may then compare the two dates and deem the requirement met at the later of the two calculated dates. An example of a condition which is age and service or points based may involve an early retirement eligibility condition that is met at the earlier of 55 years of age and 5 years of service or 70 points (age plus service). Calculation module 120 may determine the date the beneficiary attains age 55 and the date the beneficiary would have completed 5 years of service; the first alternative eligibility could be met at the later of the two calculated dates. Calculation module may then determine the date that the combination of age and service would first equal 70. These two alternative eligibility dates can then be compared with the earlier of the two dates being the date that eligibility is met.

The “date no more than” object 1406 may point to a date field contained in the beneficiary data. The “date no less than” object 1403 may allow for the reference of a date field from the data to be used as a minimum either to override the conditions object 1402 or as its own condition. This selection could be used if the eligibility for certain beneficiaries can not be calculated based on the age, service and points criteria entered in conditions object 1402, or if there are rules that are based on a specific date. The eligibility requirement could be the date in conditions that take effect once the beneficiary starts in a specific job classification. The “date no more than” object 1406 may allow for a date field to be referenced from the data that is used as a maximum either to override the exclusions object 1405 or as its own condition. Exception requirement object 1406 could be used, for example, to turn off a benefit that was discontinued as of a specific date.

Selection expression object 1407 may be one or more formulas that determine beneficiary eligibility. These formulas may use the expression language in Table 1 (FIG. 9), and reference fields from the beneficiary's data to build conditions. For example, a benefit may require that a beneficiary be hired prior to Jan. 1, 1998. If the label referenced the date of hire field HIREDATE, the user would create the following formula: HIREDATE<Jan. 1, 1998. This object could be referenced by the Eligibility Definition 809.

FIG. 15 is a block diagram showing exemplary objects that may be included in a date adjustment object 1503. The date adjustment object 1503 could comprise an adjust date object 1501 and a round date object 1502. Date adjustment object 1503 may enable rules to be specified in order to adjust the date that is calculated based on the requirements object 1401 or the selection expression object 1407 of an eligibility definition object 809. For example, benefit eligibility may be defined as the first of the month coincident with or following attainment of the eligibility criteria.

The adjust date object 1501 may be a formula employing the expression language shown in Table 1. For example, if the plan eligibility definition were the last working day of the month the beneficiary completed one year of service, the requirements object 1401 would have conditions object 1402 set to one year of service. The date adjustment object 1503 may have a component adjust date object 1501 including the formula 7 #LSTBUSDAY. This formula could take the date calculated when one year of service was attained and adjust it to the last business day of the month.

The round date object 1502 may set parameters used for the date adjustment object 1503. The round date may include parameters that can adjust the date to a timeframe and/or to a specific month and day combination. The timeframe adjustment could enable a precedence, period, and/or direction to be set. Precedence refers to the beginning of the period, end of the period, or middle of the period. The period can be a plan year, semi-plan year, calendar year, semi-calendar year, month, semi-month, bi-week, week, and/or quarter. The direction can be set to nearest, preceding, following, started, coincident with or following, or coincident with or preceding. For instance, if a DB plan defines normal retirement eligibility as the first of the month coincident with or following the attainment of age 65, the requirements object 1401 may have a condition object 1402 of age 65, and the date adjustment object 1501 may be parameterized as: beginning for the precedence, month for the period, and coincident or following for direction.

The specific month and day combination of the date rounding parameters in the date adjustment object 1501 could enable parameters to be set for direction, month, and/or day. The direction can be set to nearest, preceding, following, started, coincident with or following, or coincident with or preceding. The month and day can be any valid combination of month and day. This feature could be employed when a DB plan defines participation as a particular date (e.g., Jul. 18) following the attainment of age 18 and 6 months of service. In such a case, the requirements object 1401 could specify age 18 and 0.5 years of service as conditions to calculate the date that the condition is met, and the date adjustment object 1401 could have specific rounding parameters of: following for direction and Jul. 18 for the month day combination. This would round the date calculated to the appropriate date.

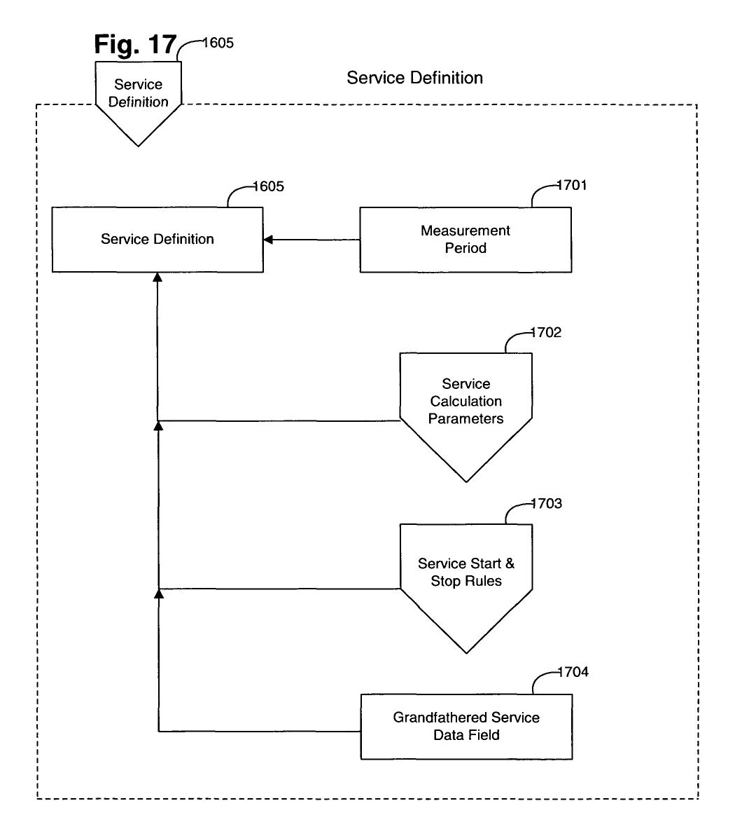

FIG. 16 is a block diagram showing the Service Definition Set 1601. The Service Definition Set 1601 may comprise one or more Service Definitions 1605, each specified as applicable for a certain range of dates. This may allow the calculation module 120 to apply different calculation methods for various date ranges due to either a plan amendment or availability of more detailed data. Additional details of Service Definition 1605 are discussed below in connection with FIG. 17.

The number of Service Definition 1605 objects that make up a Service Definition Set 1601 is not limited. For example, a DB plan may specify that benefit service is calculated on an elapsed time basis from the later of the inception of the plan or the beneficiary's participation date until Dec. 31, 1998, and after Dec. 31, 1998 the service is calculated on a conversion basis where the beneficiary accrues one year of service after completing 1000 hours of work for each plan year. In such a situation, the Service Definition Set 1601 could have two Service Definition 1605 objects, each with its own service calculation rules. The service from the elapsed time Service Definition 1605 could be frozen at Dec. 31, 1998 and added to the service from the hours conversion Service Definition 1605 (zero prior to Jan. 1, 1998), and the composite of the two service definitions could be the result of the Service Definition Set 1601.

Examples of how Service Definition Sets 1601 may be used by calculation module 120 include evaluating the service component of: United States maximum benefits 605, table 1003, accrual basis operators: standard or custom 1104, accrual rates 1106, Eligibility Definition 809, salary start rules 2401, or salary stop rules 2405.

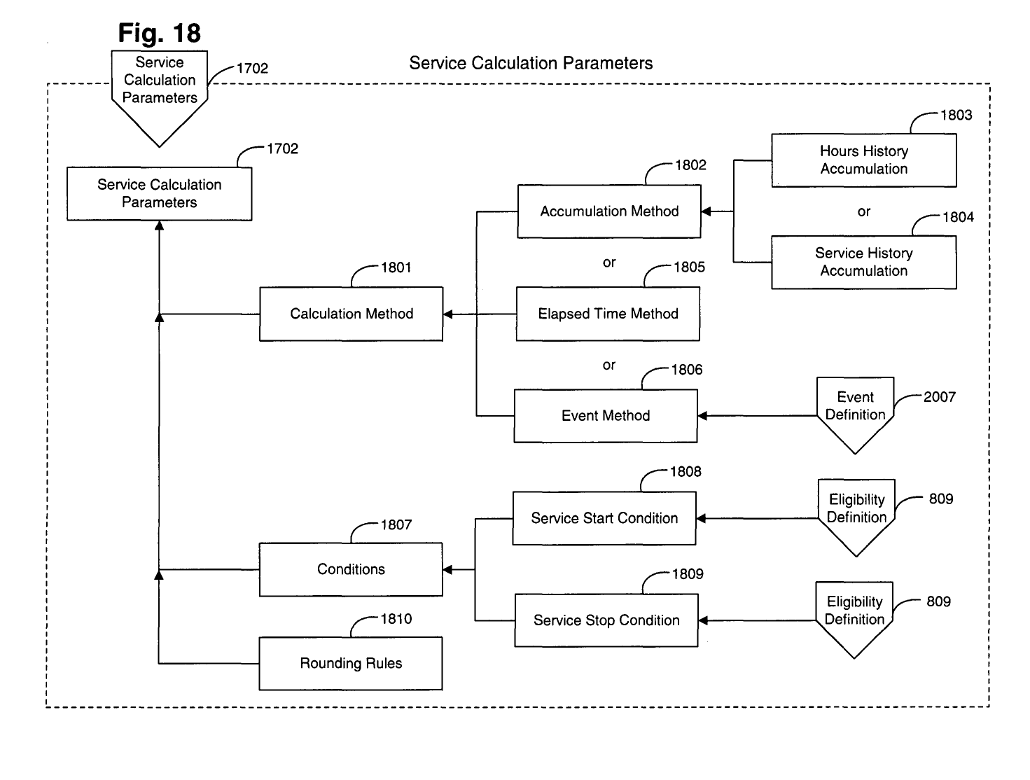

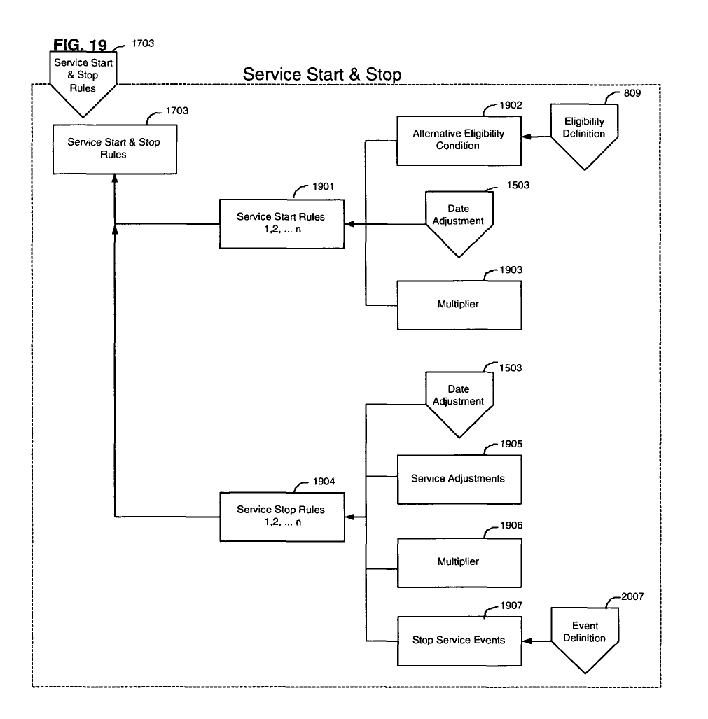

FIG. 17 is a block diagram showing exemplary objects to define a service. Service Definition 1605 may include a measurement period object 1701, service calculation parameters object 1702 (detailed in FIG. 18), Service Start & Stop Rules object (SSSR) 1703 (detailed in FIG. 19), and a grandfathered service data field 1704.

The measurement period object 1701 may set a time frame over which service is counted. Available measurement periods include calendar year, plan year, or month.

Service calculation parameters object 1702 may specify calculation method rules, conditions, and rounding rules for the calculation of service. Examples of calculation methods include elapsed time, an hours transformation, and an accumulation of units method. Conditions may determine whether service is accrued under a particular definition. For example, a DB plan may require that the beneficiary attain age 21 before service begins to accrue. The rounding rules may define how the service is rounded after it is calculated. Service calculation parameters object 1702 is shown in detail in FIG. 18.

SSSR object 1703 may enable rules and parameters to be set that determine if periods of service are included or excluded in the determination of service. These rules may be particularly concerned with the first service period, typically the year of hire, and last service period, typically the year of termination. SSSR object 1703 is shown in detail in FIG. 19.

The grandfathered service data field 1704 may enable parameterization of one or more lump sum service fields that can be added to or subtracted from the calculated service. Grandfathered service data field 1704 may reference a field in the beneficiary data that contains the lump sum service, set the parameter that indicates that the field should be subtracted from the service, and set rounding rules for the grandfathered service data field 1704. Plan providers may use grandfathered service fields to reference a fixed service amount calculated prior to the provider administering (or taking over the administration of) the DB plan. Another use of grandfathered service fields could be to subtract prior breaks in service that were hand-calculated.

FIG. 18 is a block diagram detailing exemplary service calculation parameters consistent with principles of the present invention. As illustrated in FIG. 18, the service calculation parameters object 1702 may include, or have properties such as, a Calculation Method 1801, Conditions 1807, and Rounding Rules 1810.

The calculation method 1801 may facilitate various methods for calculating service. For example, calculation method 1801 may enable the following methods to be used for the calculation of service: accumulation method 1802, elapsed time method 1805, or event method 1806. Accumulation method 1802 may also allow a user to specify an hours history accumulation 1803 or a service history accumulation 1804.

The hours history accumulation object 1803 may indicate that service is based on hours, which must be transformed to service units during the defined measurement period, and accumulated. Object 1803 may include parameters for specifying that hours must be aggregated during the measurement period before conversion and a conversion schedule for the hours to units conversion. For example, if a DB plan defines service for vesting purposes as one unit when the beneficiary works 1,000 hours in a calendar year and the census data contains hours worked during each month, the following events could transpire: First, the monthly hours may be accumulated into hours for each calendar year. The calendar year hours could then be evaluated against the conversion schedule, and the service credit for each calendar year could be determined. Finally, service in each year could be accumulated to determine total service to date.

The service history accumulation object 1804 may indicate that service is based on an accumulation of units of service earned during the defined measurement period. Object 1804 may include parameters for the data field containing the units of service and indicating that the units of service should be aggregated during the measurement period. The service history accumulation object 1804 may, for example, be used if the hours worked have already been converted to service units.

If elapsed time method object 1805 is selected, the service may be calculated as the time elapsed from the beneficiary's service start date to the earlier of the beneficiary's decrement date or the service stop date set in conditions object 1807. For example, if the DB system plan defines participation service as the service from the date of employment to the separation of service date and the beneficiary was employed on Jun. 12, 1990 and terminated employment on Jun. 15, 2000, calculation module 120 would calculate a service accrual of 10 years and 3 days.

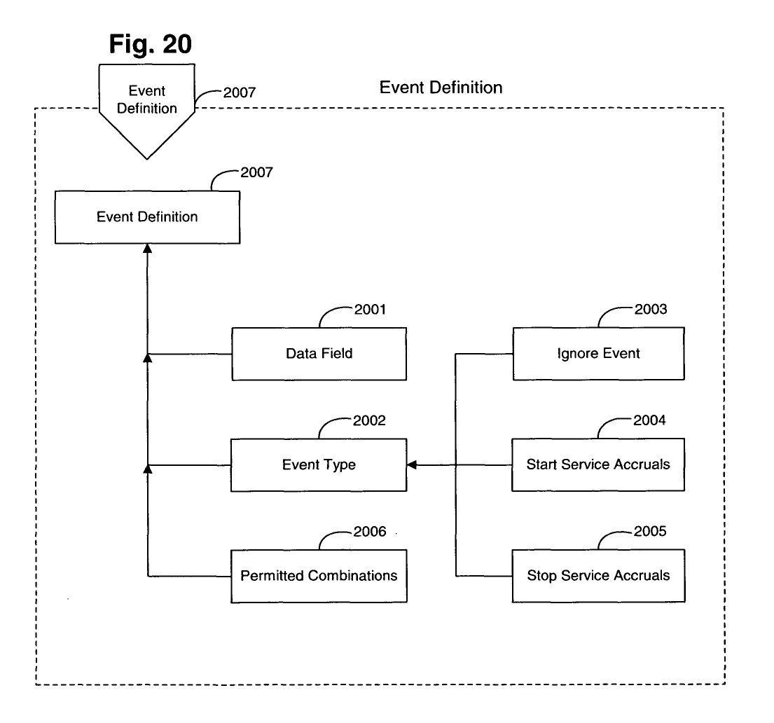

If event method object 1806 is selected, service accruals may be calculated based on an evaluation of the beneficiary's employment history and the service rules appropriate to each change in that history. Elapsed time calculations might be used while the participant was a salaried employee, but a transformation and accumulation of hours calculations might be used while the participant was an hourly employee. In addition, incremental service might be creditable during periods of international employment. The start and stop rules in conditions 1807 may be specified independently for each employment category if desired. The relevant periods of employment history and whether or not they start or stop service is defined in Event Definition 2007 object (detailed below in the discussion accompanying FIG. 20).

The conditions object 1807 may enable rules to be set which determine when service starts to accrue or stops accruing. The service start condition 1808 and the service stop condition 1809 could each use eligibility definitions 809 (detailed in FIG. 14) to set conditions that determine if the member is entitled to accrue service. For example, benefit service may not start to accrue until the beneficiary reaches age 21 and earns 1 year of vesting service, and benefit service may cease accruing after 30 years of service. Moreover, once service starts, the DB system plan may or may not retroactively recognize the period of employment prior to the service-starting event (e.g., reaching age 21 and 1 year of vesting service) in the benefit calculation.

The rounding rules object 1810 may set conditions for rounding the service after it has been calculated. The rounding rules object 1810 may include parameters that can be set for the amount and the number of decimal places. Amount rounding may specify how the number is rounded and the direction. The amount may be a value indicating the rounding, and the direction could indicate whether numbers should be rounded up, down, or to the nearest multiple of the amount. For example, if the service is rounded to the nearest thousandth, the amount may be set to 0.001 and the direction set to “nearest.” The decimal place parameters may indicate the precision to which a number should be rounded. The number of decimal places may be a value indicating the number of decimal places, and the direction could indicate whether numbers should be rounded up, down, or to the nearest decimal. For example, if the service is rounded to the nearest thousandth, the decimal places might be set to 3 and the direction set to “nearest.”

FIG. 19 is a block diagram showing objects comprising SSSR object 1703. SSSR object 1703 may, for example, include one or more Service Start Rules 1901 and one or more Service stop rules 1904 objects.

Service start rules 1901 may comprise one or more of an alternative eligibility condition 1902, a date adjustment 1503 (detailed in FIG. 15), and a multiplier 1903. Service start rules 1901 may define when service starts to accrue and how service is subsequently calculated. The alternative eligibility condition 1902 may use the Eligibility Definition 809 to establish another eligibility condition that is evaluated in the starting of service. The date adjustment 1503 may set parameters for adjusting the date at which eligibility is met after the conditions are determined. The multiplier 1903 may set the rate at which service is assumed to accrue for each measurement period after the start conditions are met.

The alternative eligibility conditions 1902 may set an override rule for determining when service starts to accrue. The alternative eligibility conditions 1902 may use eligibility definitions 809 in the same manner as service start conditions 1808 (as described above). The eligibility definitions 809 may establish conditions for determining whether the beneficiary is entitled to accrue service. For example, benefit service may not start accruing until the beneficiary reaches age 21 and earns 1 year of vesting service. Due to acquisition activity, however, any active employee of an acquired company may begin to accrue benefit service on the acquisition date. Accordingly, the conditions 1807 could be used to establish the service start condition 1808 of age 21 and 1 year of service, and the alternative eligibility condition 1902 could be used to set up the criteria that determine members of an acquired group. Both sets of conditions may be evaluated, and service could be deemed to start as of the earliest date the beneficiary satisfies either condition.

As mentioned above, the multiplier 1903 may establish a rate at which service is assumed to accrue for each measurement period. Various rate types may be employed such as a constant rate specified as the amount of service accrued during the measurement period, may be used for service accrual, or information from the beneficiary's data may be used to specify the rate. For example, a numeric field could be included in a beneficiary's data to reflect the periodic accrual of service. If the rate is determined via such a data field, frequently reported accruals may be accumulated into accruals for a given measurement period.

As FIG. 19 illustrates, the service stop rules 1904 object may comprise a date adjustment 1503, service adjustments 1905, a multiplier 1906, and stop service events 1907. Service stop rules 1904 may define when service stops accruing. For example, service may be specified as continuing to age 65 upon a disability event. The service adjustments 1905 may allow for adjustments in the calculation of service. The stop service events 1907 may use Event Definition 2007 (detailed in FIG. 20) to determine what combination of data changes indicates a cessation of service accrual.

FIG. 20 is a block diagram showing the Event Definition object 2007. As illustrated, Event Definition object 2007 may include a Data Field 2001, an Event Type 2002, and Permitted Combinations 2006. The Event Definition object may be used to evaluate employment status changes, which may be integral to various service calculations. Object 2001 may allow a user to select any array field from the data to determine such status changes.

Event Type 2002 may include an Ignore Event 2003, Start Service Accruals 2004, and Stop Service Accruals 2005. The Ignore Event 2003 may specify that a particular employment status change be ignored for purposes of service calculation. The Start Service Accruals 2004, however, may indicate that a particular status change triggers service accrual, and the Stop Service Accruals 2005 may indicate the status change stops the beneficiary's service accrual. In certain DB plans, beneficiary statuses may include: ineligible, active, terminated, leave, and retired.

The Permitted Combinations 2006 may allow a user to set conditions for status changes, a message that should be returned when a status change occurs, or a corresponding action that calculation module 120 should perform. If the user sets a warning condition, calculation may continue uninterrupted, although calculation may be terminated in response to an error condition. Messages may be returned in response to various status changes and/or conditions. For example, if a user prevents (via a condition) a status change from active to ineligible from occurring, the following message could be returned: “invalid status change had occurred.”

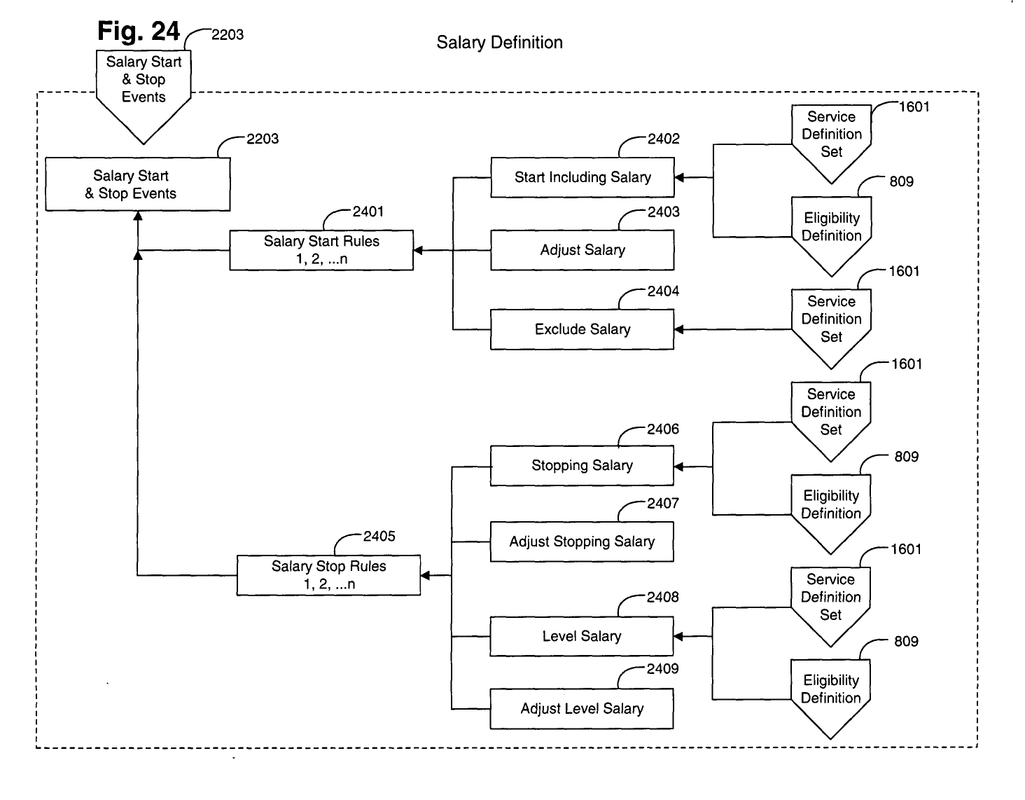

FIG. 21 is a block diagram showing the Salary Definition Set 2101, which may include one or more Salary Definition objects 2104. In one embodiment, Salary Definition Set 2101 may enable calculation module 120 to apply different Salary Definitions (2104) to various date ranges to accommodate historical DB plan rules. Further details of Salary Definitions 2104 are explained below in connection with FIG. 24.

Although three Salary Definitions are shown, any number of Salary Definitions 2104 objects may be included in a given Salary Definition Set 2101. For example, a DB plan may define compensation for benefits as: base salary from the inception of the plan until Dec. 31, 1995 and Box 10-W2 pay after Dec. 31, 1995. In such a situation, Salary Definition Set 2101 could include two Salary Definition 2104 objects, each having unique rules. In certain implementations, calculation module 120 may use Salary Definition Set 2101 to evaluate the salary component of United States maximum benefits 605 and/or accrual basis operators 1104.

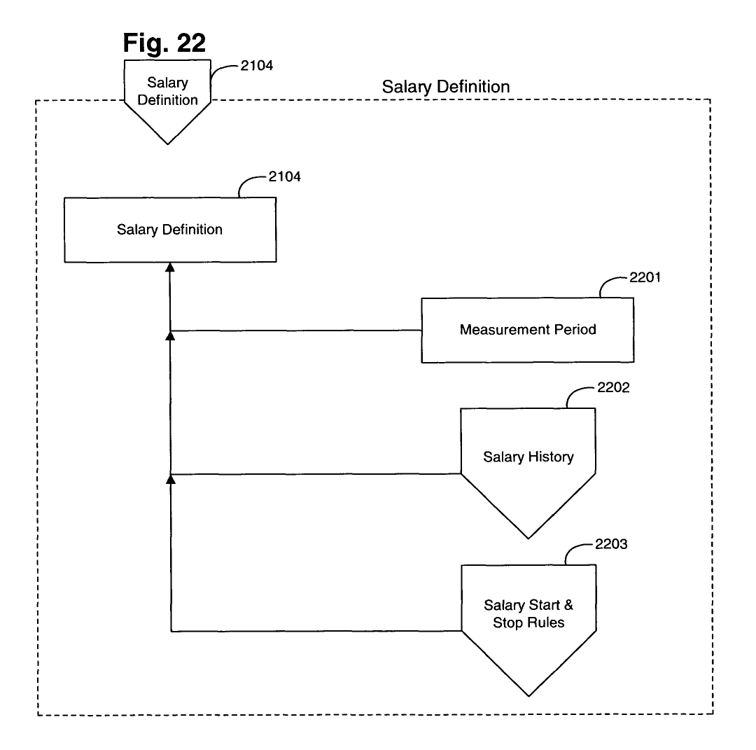

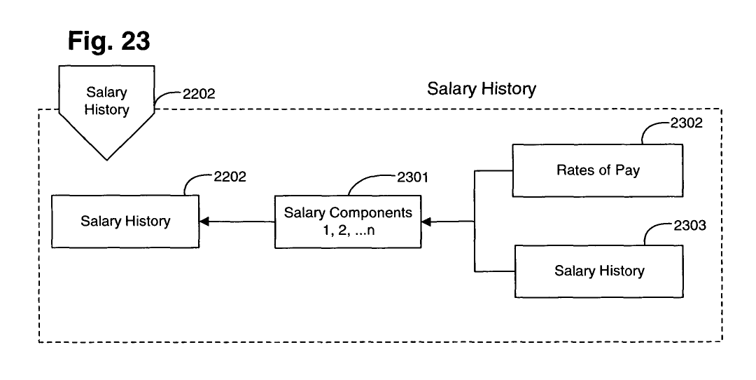

FIG. 22 is a block diagram showing objects included in an exemplary Salary Definition 2104. As FIG. 22 illustrates, Salary Definition 2104 may include a Measurement Period object 2201, a Salary History object 2202 (discussed below in FIG. 23), and a Salary Start and Stop Events object 2203 (discussed below in FIG. 24).

Measurement Period object 2201 may define a time frame used for grouping and measuring salaries. Examples of measurement periods include a plan year, a calendar year, a month, and a “month from less frequent salaries.” The “month from less frequent salaries” may spread the salary evenly over a plurality of months based on the salary start and stop date.

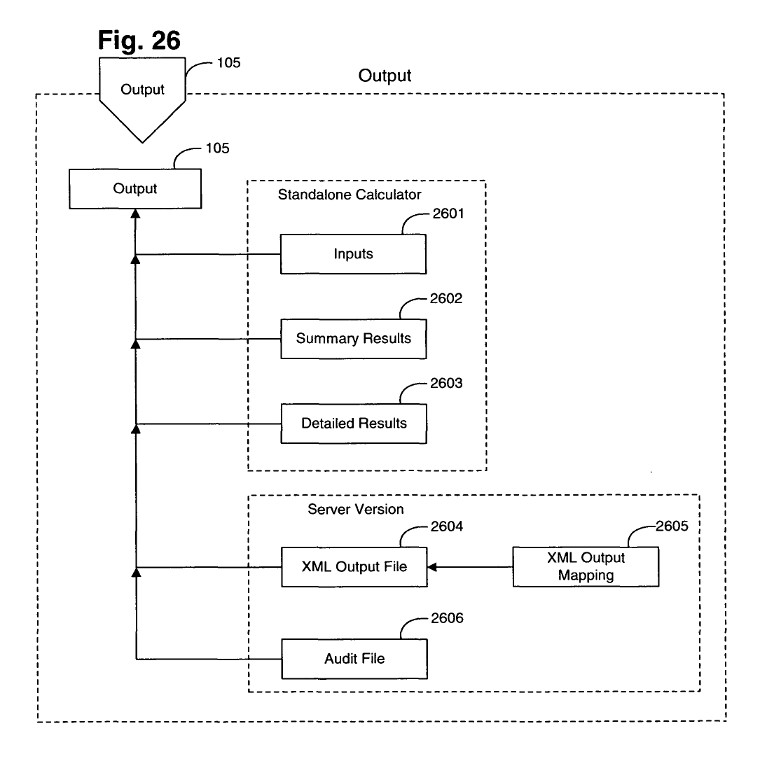

The Salary History object 2202 may aggregate one or more components of a given beneficiary's pay that are used to build the Salary Definition. The Salary Start and Stop Rules object 2203 may set rules and parameters for determining whether salaries are included or excluded in the determination of a service definition. Additional details regarding Salary Start and Stop Rules object 2203 are presented in connection FIG. 26.

FIG. 23 shows exemplary objects included in the Salary History 2202. As FIG. 23 illustrates, the Salary History object 2202 may include one or more Salary Components 2301. The Salary Components 2301 may be a rate of pay 2302 or a salary history 2303. Calculation module 120 may add salary components based on the measurement period to build the salary history 2202.

The rate of pay 2302 may indicate that the salary component is not necessarily equivalent to actual pay received. Rate of pay 2302 may include parameters, such as a data field and a rate frequency, for enabling the calculation module 120 to assemble the pay rates based on the measurement period. The data field may reference any field set up in the database linkage 502 having an effective date and/or a start and stop date dimension. The rate frequency may be fixed for all members or may vary for each beneficiary and be determined by a beneficiary-specific data field. For example, a DB plan may classify beneficiaries as either hourly or salaried employees. In such a plan, the benefit formula may be 1% of the beneficiary's annual rate of pay for each calendar year in which the beneficiary works at least 1,000 hours. For the hourly employee, data fields may contain the rate of pay and indicate that the rate of pay is hourly. For a salaried employee, those data fields may contain the pay rate and a field that indicates an annual pay rate.

FIG. 24 shows the Salary Start & Stop Events 2203 objects utilized to define the calculation of Salaries for a Salary Definition 2104. Salary Start & Stop Events 2203 may be used to determine if salaries for a period are included or excluded in the Salary Definition. As illustrated in FIG. 24, Salary Start & Stop Events 2203 may comprise one or more Salary Start Rules 2401 and Salary Stop Rules 2405.

The Salary Start Rules 2401 may comprise a start including salary 2402, an adjust salary 2403, and an exclude salary 2404 object. Start including salary 2402 may allow rules to be set that determine if salary is included in the salary definition 2104. The start including salary 2402 makes use of eligibility definition 809 and the service definition set 1601 to set the conditions that determine if the salary is included. See FIG. 8 for more details on the objects and build of eligibility definition 809 and FIG. 16 for more details on the objects and build of service definition set 1601. In one example, a member's salary may be included once they have worked one year for the employer. In such a case, the user could set up an eligibility definition 809 with a requirement of one year of service and a service definition set 1601 that calculated service on an elapsed time basis. The system would then determine the beginning date that salaries are included in the salary definition 2104.

Adjust salary 2403 may allow the user to set the rules for determining how to adjust salaries where the reported salary is less than or greater than the measurement period. If the reported salaries cover a time period less than the measurement period, the user can set the rules for grossing up the salary. If the reported salaries cover a time period greater than the measurement period, the user can set the rules that prorate the salary.

Exclude salary 2404 may allow rules to be set that determine if an individual salary is excluded in the salary definition 2104. The exclude salary 2404 makes use of service definition set 1601 to set the conditions that determine if the salary is excluded. See FIG. 16 for more details on the objects and build of service definition set 1601. For example, if the member's salary is excluded for the calculation of benefits during any calendar year when he works less than 1,000 hours, the user could reference a service definition set that credited one year of service when hours worked are greater than 1,000. The user could then check the box indicating that salary is excluded if less than 1 year of service is earned.

The salary stop rules 2405 may allow for setting rules that determine when the salary stops accruing. The salary stop rules 2405 may comprise a stopping salary 2406, an adjust stopping salary 2407, a level salary, 2408, and an adjust level salary 2409 object. The stopping salary 2406 object may allow rules to be set that determine a date when salaries are no longer included in the salary definition 2104. The stopping salary 2406 makes use of eligibility definition 809 and the service definition set 1601 to set the conditions that determine this date. See FIG. 8 for more details on the objects and build of eligibility definition 809 and FIG. 16 for more details on the objects and build of service definition set 1601.

Adjust stopping salary 2407 allows the user to set the rules for determining how to adjust salaries in the measurement period containing the stop date. The user can indicate that no adjustment is necessary, set the salary to the previous period salary, prorate the current salary, or gross up the salary.

The level salary object 2408 may use the eligibility definition 809 and service definition set 1601 objects to set the date that salaries are assumed to remain level. The level salary 2408 makes use of eligibility definition 809 and the service definition set 1601 to set the conditions that determine this date. See FIG. 8 for more details on the objects and build of eligibility definition 809 and FIG. 16 for more details on the objects and build of service definition set 1601.

The object adjust level salary 2409 allows the user to set the rules for determining how to adjust salaries in the measurement period containing the stop date. The user can indicate that no adjustment is necessary, set the salary to the previous period salary, prorate the current salary, or gross up the salary.

FIG. 25 illustrates exemplary rules that calculation module 120 may evaluate in calculating payment forms for an accrued benefit. As illustrated in FIG. 25, the payment form 804 may include one or more of the following objects: Form Rules 2501, an Eligibility 2502, a Conversion 2503, Lump Sum Rules 2506, and Level Income Rules 2507.

Form Rules object 2501 may set the type of payment, a deferral period, a temporary period, and/or Cost Of Living Assumptions (COLA). Type of payment may specify how, or in what form, a payment should be made. In certain embodiments of the invention, lump sum payments and/or annuity payments of the following types may be provided: life, joint life, certain only, certain and life, certain and joint life, and level income. The type of payment chosen may require additional parameters. For example, certain forms of payment require a certain period to be specified. The joint life form of payment may require a percentage continuation to be set for the periods while both the employee and beneficiary are alive, while only the employee is alive, and while only the beneficiary is alive. The deferral period, temporary period, and COLA may enable a deferral age, a temporary age (or years), and a COLA rate to be set during the payment period and/or deferral period. If the payment type is lump sum, the appropriate rules may set in Lump Sum Rules 2506. If the payment type is level income, the appropriate rules may be set in Level Income Rules 2507.

The rules set in eligibility 2502 may determine which members are entitled to the payment form 804. The eligibility 2502 can be set similar to benefit definitions or an alternative eligibility. If the rule is set similar to benefit definitions, rules set in eligibility requirements & United States 415(b) maximum benefits 802 may be used. This is described in more detail in FIG. 8. If the user selects alternative eligibility, the Eligibility Definition 809 may include rules, based on age, service, points (i.e., age plus service) and/or data, which a beneficiary must meet, including any applicable date adjustment 1503. For example, a participant meeting the age 55 and 10 years of service requirement on February 17^{th} may not be eligible for the benefit until March 1^{st} (the first of the month coincident with or following attainment of eligibility). The Service Definition Set 1601 can be used to calculate a service component of the Eligibility Definition 809. Consistent with principles of the present invention, a plurality of different criteria may be established and specified, each of which can be evaluated by calculation module 120 to determine if the beneficiary is entitled to a Payment form 804. For example, if a DB plan's eligibility criteria involves two types of service (e.g., vesting service and participation service), two different and corresponding criteria can be set to determine eligibility.

In one implementation, the conversion 2503 object may set various methods for conversion and rules for determining the factors and ages. Three examples of such conversion methods include no conversion, table 2504, and actuarial equivalence 2505. The no conversion option indicates that the benefit calculated does not require adjustment. The table 2504 option may cause conversion to be based on a table of imported conversion factors. The actuarial equivalence 2505 option may cause conversion to be based on member mortality, beneficiary mortality, and/or interest rates.

Lump Sum Rules 2506 may include user-specified parameters for setting GATT style, PBGC style, alternative PBGC and/or a maximum value. Object 2506 may also use the actuarial equivalence 2505 object to determine the present value of benefits.

Level Income Rules 2507 may include user-specified parameters for setting a Social Security start age and/or a primary insurance amount for determining the level income benefit. The Social Security start age may be either a beneficiary's Social Security Normal Retirement Age or a pre-defined age. The primary insurance amount may use an amount calculated by the system plan, an amount sent in response to a request, and/or an amount calculated by the system plan that is overridden if a value is passed on the request. If an amount calculated by the system plan is used, the Accrual Basis Operator 1104 may be employed.

FIG. 26 shows exemplary objects that may be included in the output 105.

Output 105 may include objects used by a standalone calculator (e.g., 135) and/or objects used by a server (e.g., calculation server 350). The standalone objects may include inputs 2601, summary results 2602, and detailed results 2603. The server objects may include XML output 2604 and audit report 2606.

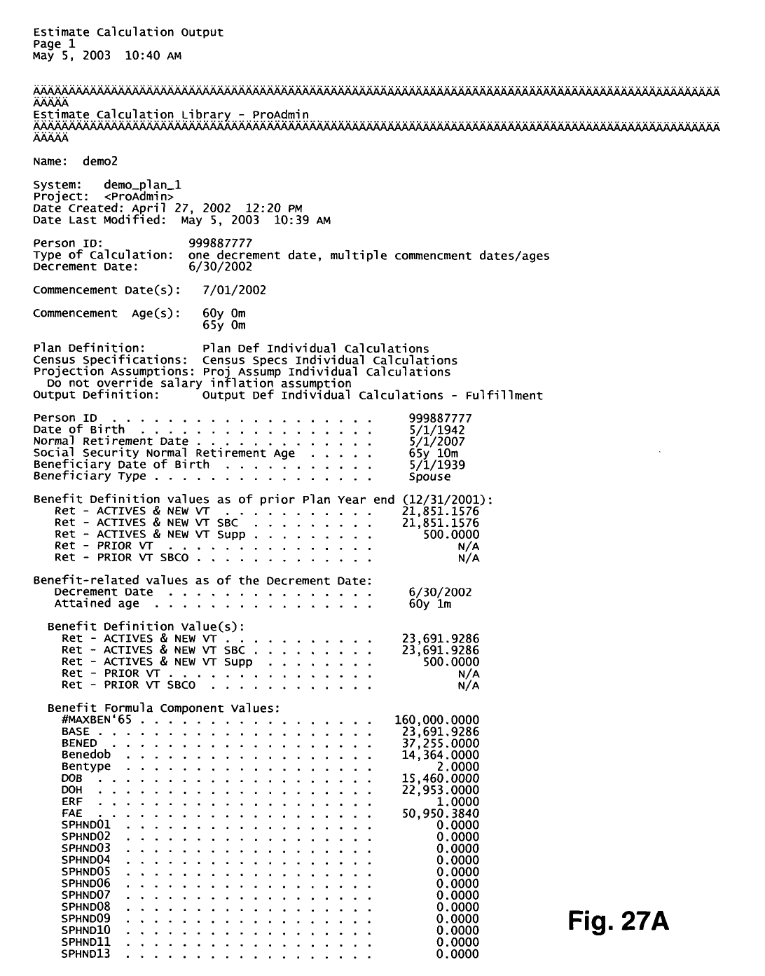

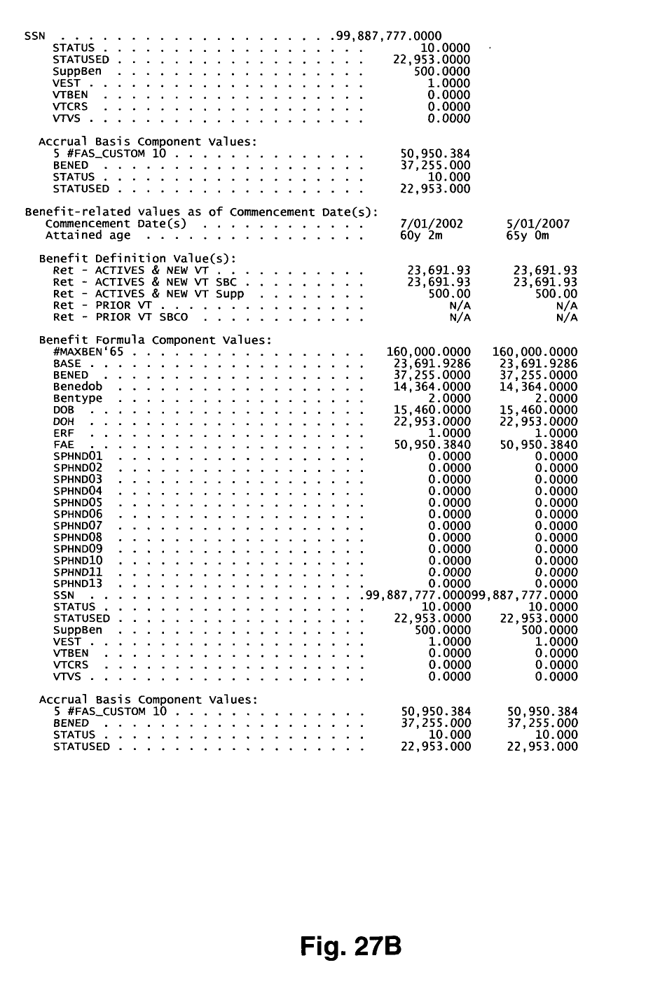

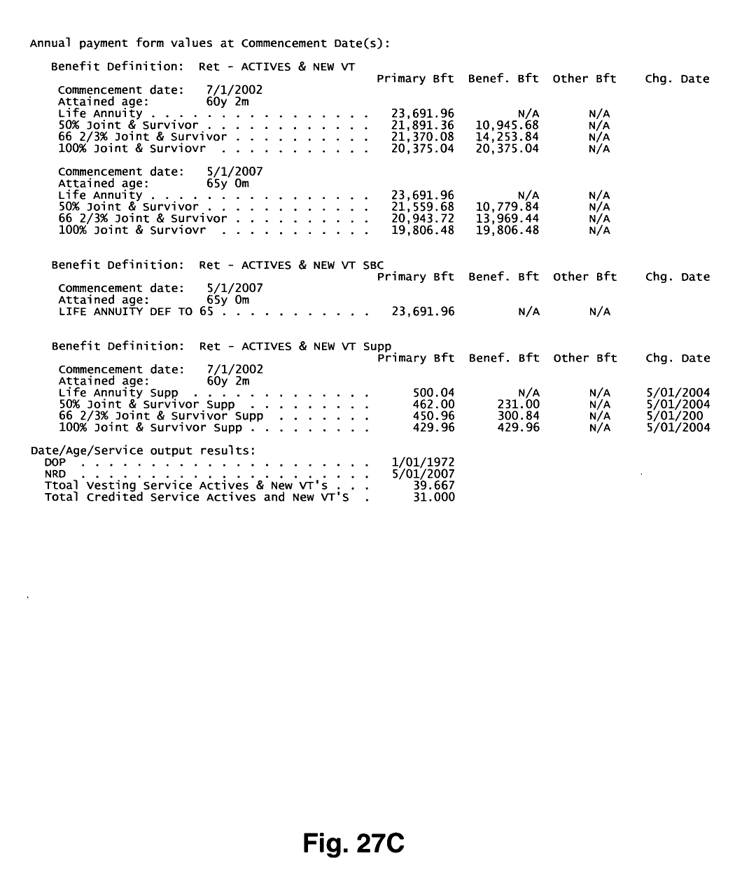

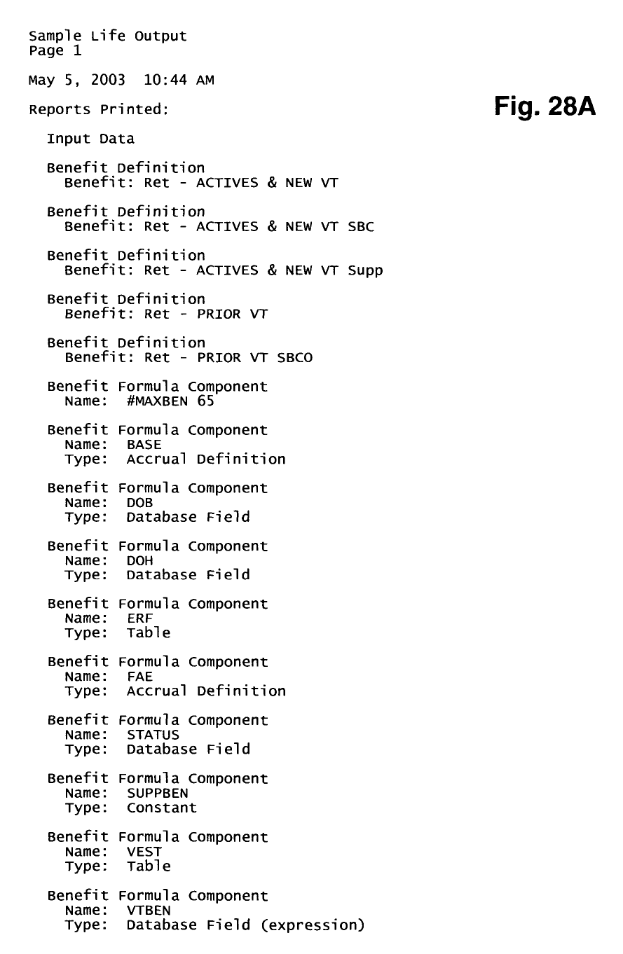

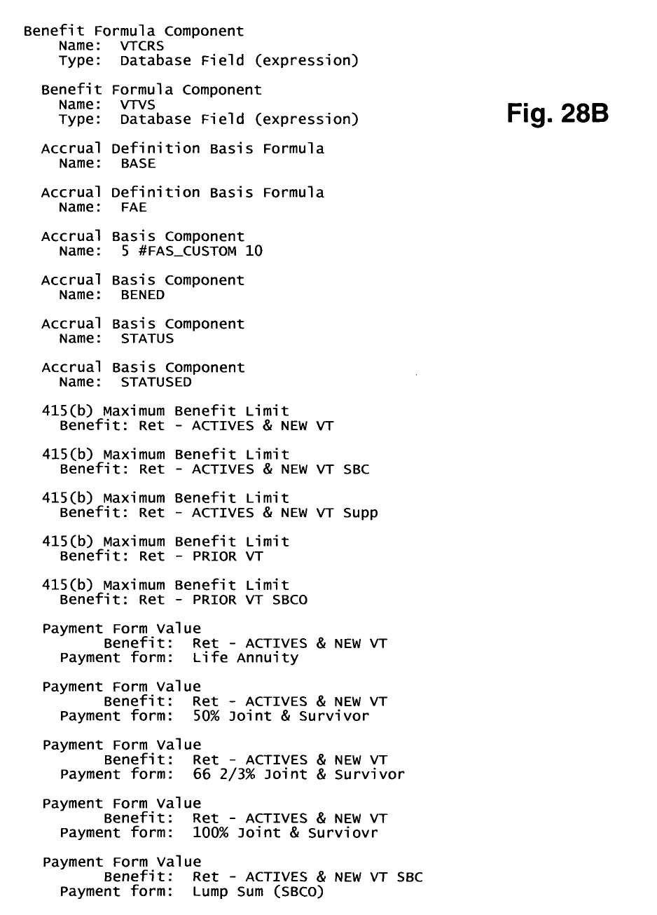

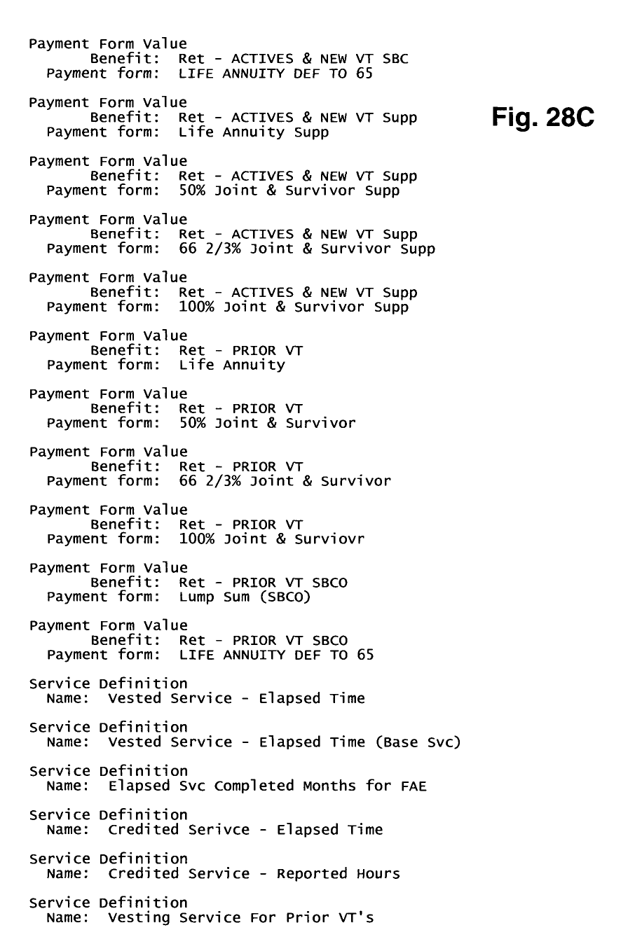

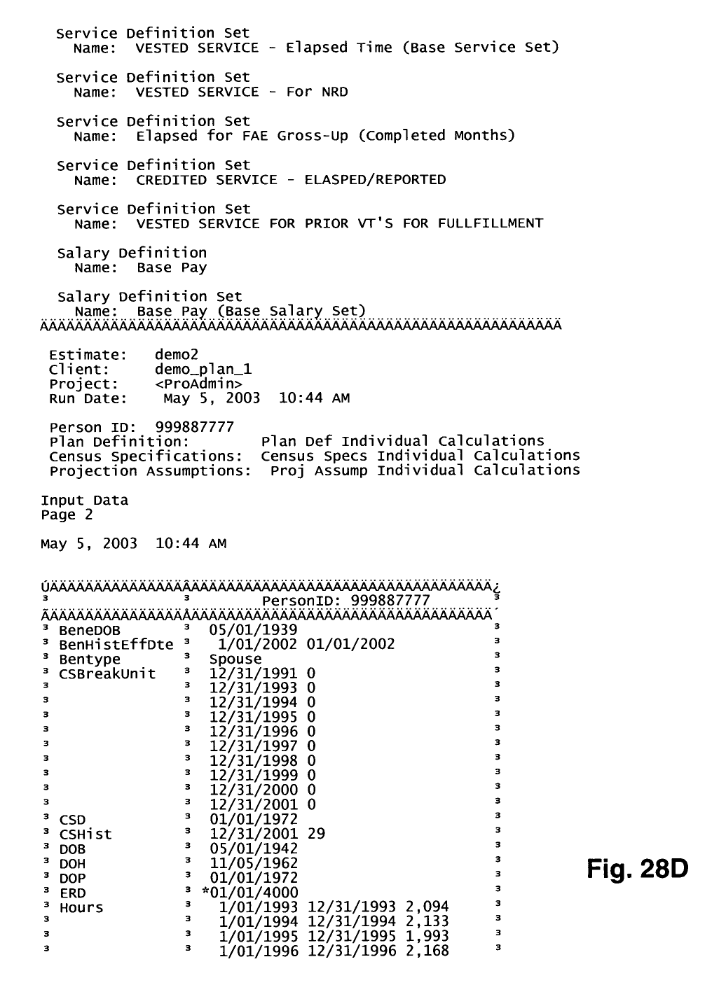

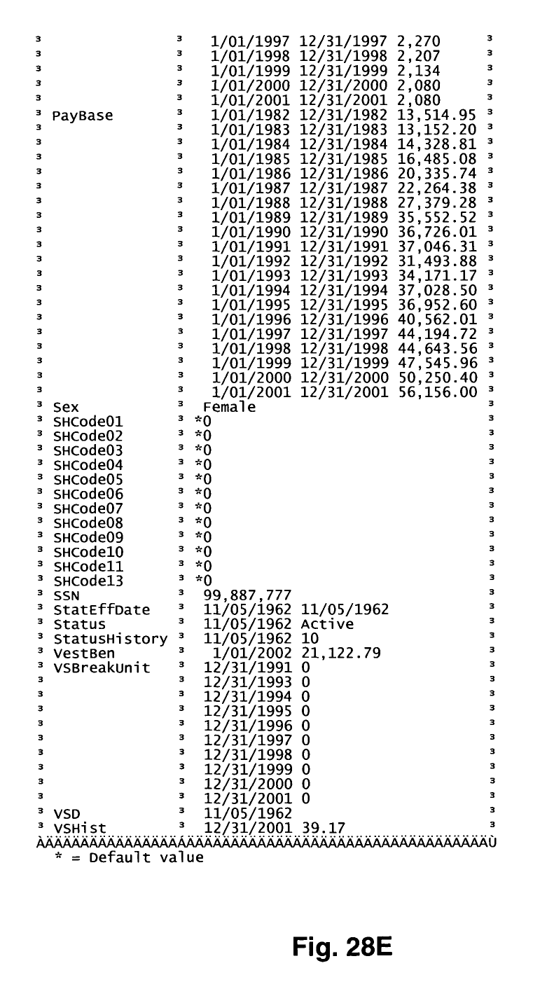

As explained above, a user may validate rules and formulas before they are loaded to repository 125 via data processing system 135. The standalone output objects may be used to validate the calculation rules and formulas. Inputs 2601 may produce a report detailing all of the plan rules and formulas (e.g., 103) and a received calculation request (e.g., 101) executed by the calculation module 120. Summary Results 2602 may produce results of calculations performed by calculation module 120 for formulas and rules included in benefit definition 604, benefit formula 803, payment form 804, benefit components 1002, accrual basis operators from accrual basis 1102, Service Definition Set 1601, and/or Salary Definition Set 2101. An example summary report is illustrated in FIGS. 27A-27C. Detailed results 2603 may produce a report showing data, associated with a particular beneficiary, used in calculations performed by calculation module 120 and details of how calculation module 120 derived the values for benefit definition 604, benefit formula 803, payment form 804, benefit components 1002, accrual basis operators from accrual basis 1102, Service Definition Set 1601, Service Definition 1605, Salary Definition Set 2101, and/or Salary Definition 2104. An exemplary portion of such a report including such detailed results is illustrated in FIGS. 28A-28E.

Calculation server 135 can also produce an XML output file 2604 and an audit report/file 2606. The XML output file 2604 may use XML output mapping 2605. Output mapping 2605 may be configured to link XML tags to the calculations performed by calculation module 120.

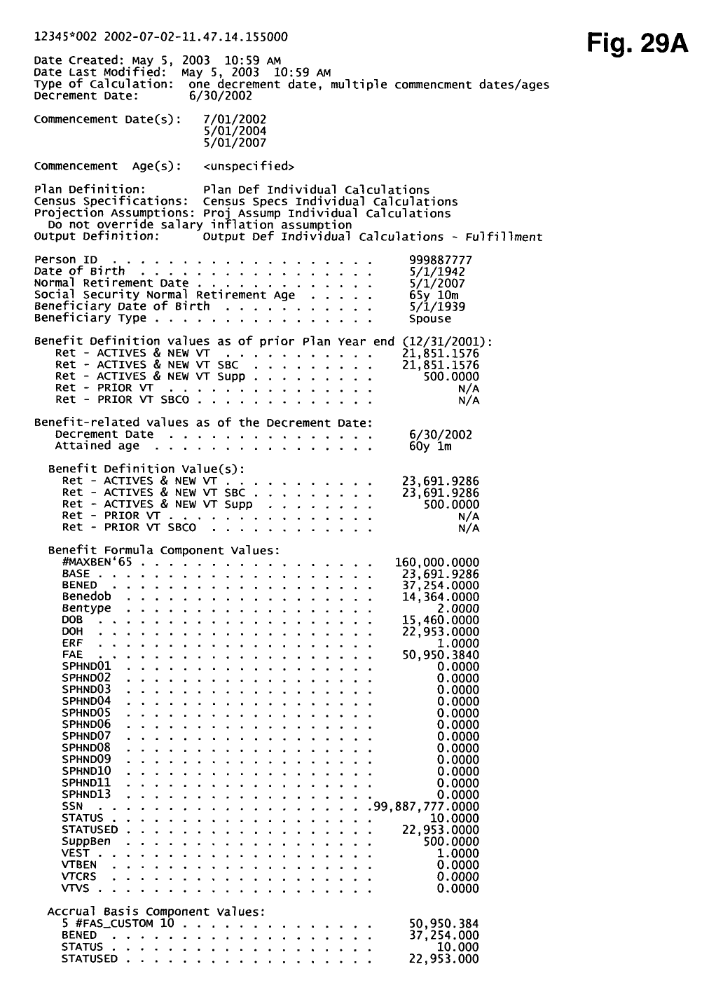

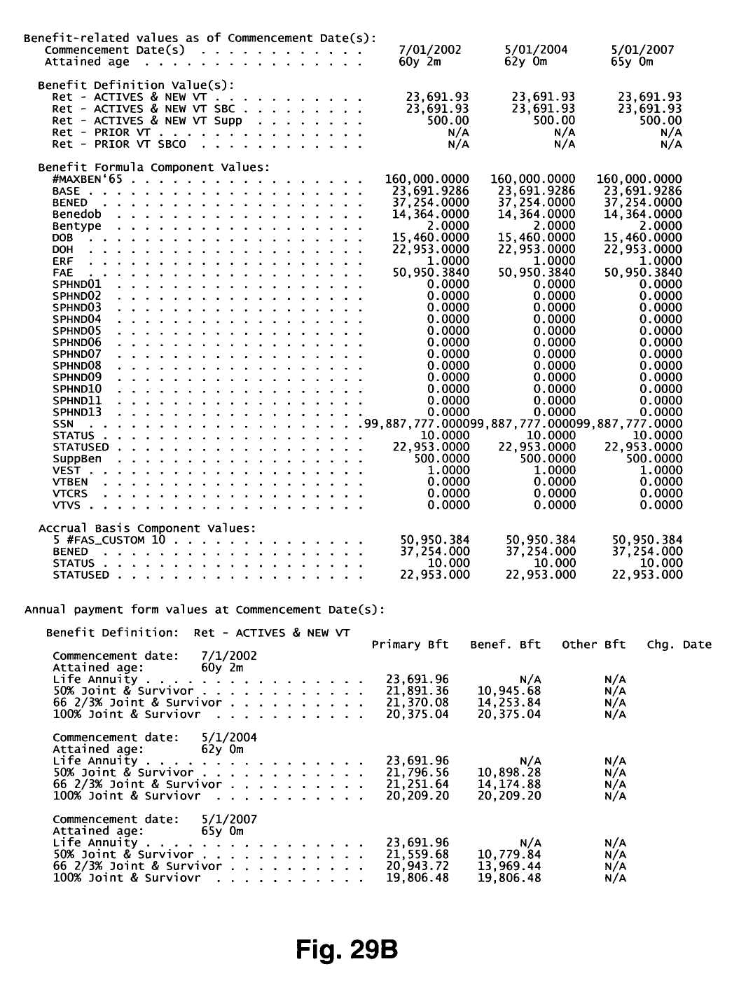

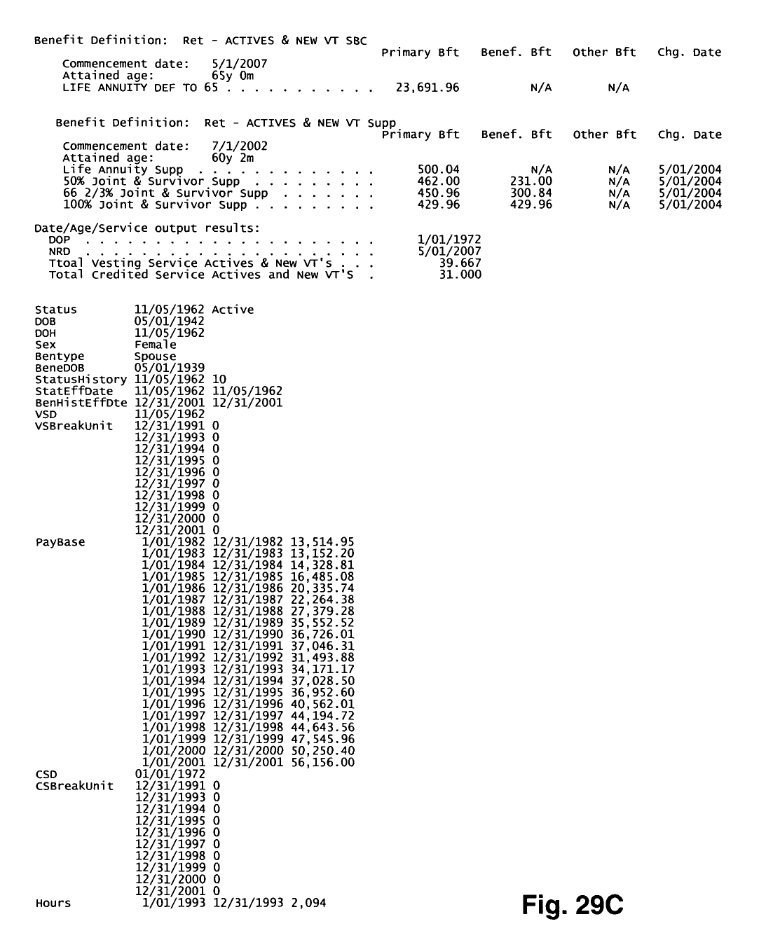

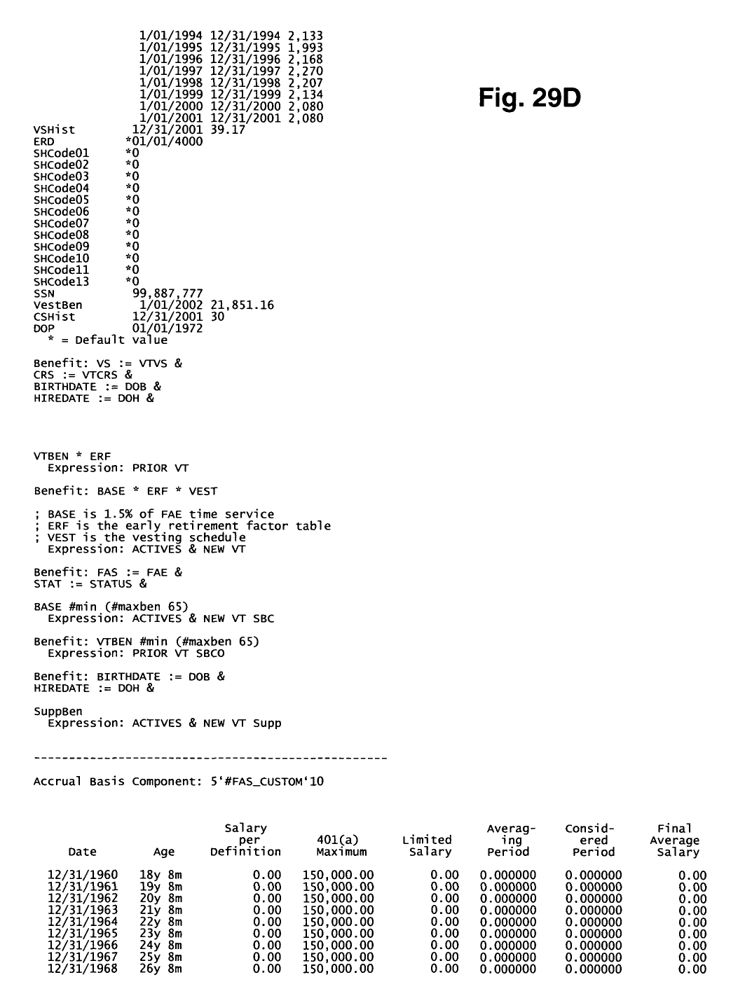

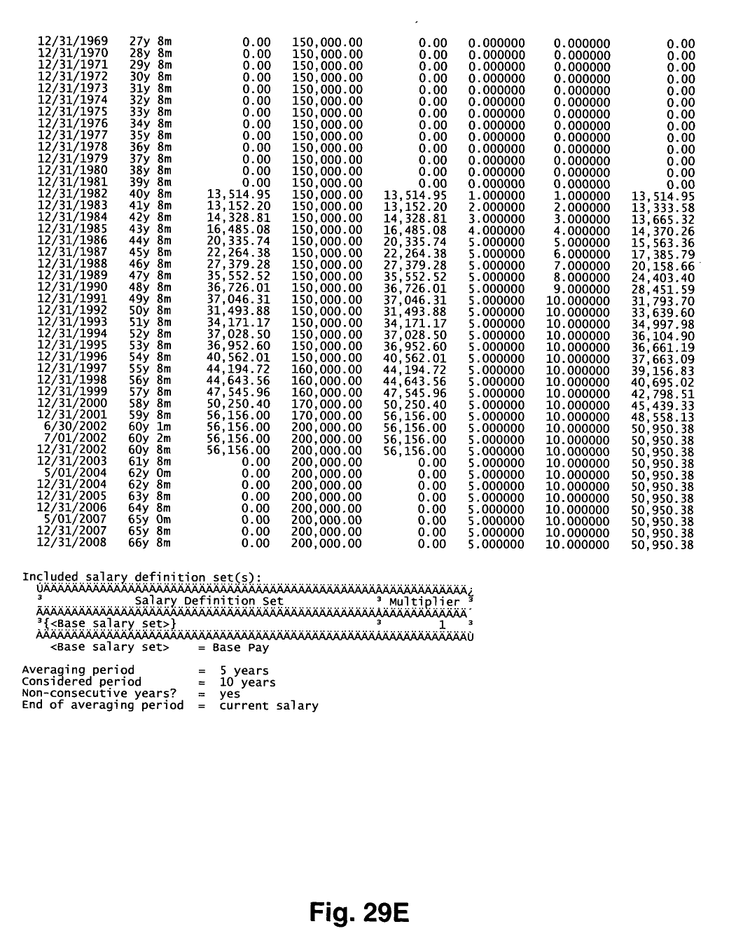

As mentioned above, FIG. 7 shows a sample XML output file. The audit file 2606 may produce a text file report that provides a summary of results associated with calculations performed by calculation engine 102. An example of such a report is illustrated in FIGS. 29A-29E. These results may be associated with the formulas and rules included in benefit definition 604, benefit formula 803, payment form 804, benefit components 1002, accrual basis operators from accrual basis 1102, Service Definition Set 1601, and/or Salary Definition Set 2101.

For clarity of explanation, the elements included in and/or used by calculation module 120 (and other components of system 10) are described herein with reference to the discrete functional elements/objects illustrated in FIGS. 5-26, but the functionality of these elements/objects may overlap or may exist in a fewer or greater number of elements/objects. Further, the elements/objects depicted in FIGS. 5-26 (e.g., 503, 604, 803, 1605, etc.) may, depending on the implementation, lack certain illustrated components or include additional or varying components not shown. Alternatively, all or part of the functionality of the elements illustrated in FIGS. 5-26 may co-exist in the same location or be distributed among several geographically dispersed locations.

Embodiments consistent with the invention may be implemented in various environments. Further, the processes described herein are not inherently related to any particular apparatus and may be implemented by any suitable combination of components.

The exemplary systems and methods consistent with present invention described above are illustrative rather than restrictive. Different combinations of hardware, software, and firmware may be suitable for practicing embodiments of the present invention.

Additionally, other embodiments of the invention will be apparent to those skilled in the art from consideration of the specification and practice of the invention disclosed herein. Thus, the true scope and spirit of the invention depends on the following claims.

What is claimed is:

1. A method for determining benefits, comprising:
enabling a user to create provisions for a benefit plan using an expression language;
maintaining the provisions in a repository;
receiving, by a calculation module, a request for a benefit determination;
accessing, by the calculation module, the provisions from the repository in response to the request;
accessing, by the calculation module, benefit data associated with the benefit plan; and
providing, via the calculation module, the benefit determination based on the provisions and the benefit data.

2. The method of claim 1, further comprising:
outputting the benefit determination.

3. The method of claim 1, wherein accessing benefit data includes accessing at least one of census information, market rates, historical interest rates, economic indices, and regulatory provisions.

4. The method of claim 1, wherein accessing the provisions comprises identifying the system plan provisions using information included in the request.

5. A method for determining benefits, comprising:
enabling a user to create provisions for a benefit plan via an expression language;
associating the provisions with a system plan;
receiving, by a calculation module, a request to perform a benefit calculation;
identifying, via the calculation module, the system plan using information included in the request;
accessing, by the calculation module, the system plan from a repository; and
performing, by the calculation module, the benefit calculation using the provisions.

6. The method of claim 5, wherein enabling the user to create the provisions includes enabling the user to create at least one formula.

7. The method of claim 6, wherein performing the benefit calculation includes performing the benefit calculation according to the at least one formula.

8. The method of claim 5, wherein enabling a user to create provisions comprises enabling the user to create the provisions via a standalone data processing system.

9. The method of claim 5, further comprising:
enabling the user to validate the provisions prior to associating the provisions with the system plan.

10. The method of claim 5, further comprising:
accessing benefit data associated with the benefit plan from a database.

11. The method of claim 10, wherein accessing benefit data includes accessing at least one of census information, market rates, historical interest rates, economic indices, and regulatory provisions.

12. The method of claim 11, wherein performing the benefit calculation comprises performing the benefit calculation using the provisions and the accessed benefit data.

13. The method of claim 5, wherein performing the benefit calculation comprises calculating a benefit payable to a beneficiary.

14. A system for performing benefit calculations, comprising:
a plan provider for administering a benefit plan to a beneficiary;
a data processing system for enabling the plan provider to generate provisions, via an expression language, for the benefit plan;
a repository for maintaining the provisions; and
a calculation module, coupled to the repository, configured to:
receive a calculation request from a resource associated with the plan provider;
access the provisions from the repository in response to the request;
perform at least one calculation of a type specified in the request using the provisions; and
generate an output for presenting at least one result associated with the at least one calculation.

15. The system of claim 14, wherein the benefit plan is a retirement program through which an employer provides post-employment benefits to the beneficiary.

16. The system of claim 14, wherein the data processing system is a standalone desktop computer.

17. The system of claim 14, where in the data processing system contains an interface that transmits the provisions to the repository.

18. The system of claim 14, wherein the data processing system contains an interface that enables the user to validate the provisions by running sample calculations.

19. The system of claim 18, wherein the data processing system contains an interface that transmits the provisions to the repository after the user validates the provisions.

20. The system of claim 14, wherein the repository is a data structure residing on a computer drive.

21. The system of claim 14, wherein the repository is at least one of a relational database, a distributed database, and an object-oriented programming database.

22. The system of claim 14, wherein the calculation module includes an application software module residing on a server.

23. The system of claim 14, wherein the resource associated with the plan provider is at least one of an Internet, an intranet, a personal computer, a call center, and a voice response unit.

24. The system of claim 14, wherein the calculation request includes an identifier associated with the benefit plan for retrieving the provisions from the repository.

25. The system of claim 14, further comprising a storage device for maintaining benefit data.

26. The system of claim 25, wherein the benefit data includes at least one of census information, market rates, historical interest rates, economic indices, and regulatory provisions.

27. The system of claim 25, wherein the calculation module is configured to perform the calculation specified in the request using the provisions and the benefit data.

28. A calculation module comprising:
means for receiving a calculation request from a resource associated with a plan provider;
means for identifying a system plan using information included in the calculation request;
means for identifying at least one calculation type from the information included in the calculation request;
means for retrieving, from the system plan, data required to perform the at least one calculation type;
means for performing the calculation type using the retrieved information; and
means for generating an output for displaying results of the calculation type to the user.

29. A system for performing benefit calculations, comprising:
provider means for administering a benefit plan to a beneficiary;
setup means for enabling a user to generate provisions, via an expression language, for the benefit plan;
validation means for validating the provisions;
repository means for maintaining the provisions; and
calculation means for:
receiving a request to perform a calculation for the benefit plan;
retrieving the provisions from the repository means in response to the request;
performing the calculation using the provisions; and
generating an output including a result associated with the calculation.

30. The system of claim 29, wherein the calculation includes calculating an interest accrual associated with the beneficiary.

31. The system of claim 30, further comprising:
accrual means, coupled to the calculation means, for calculating the interest accrual; and
structure means for specifying an interest rate structure to be used by the accrual means, said structure means including:
a first interest rate table including an historical index of rates,
means for receiving instructions to adjust interest rates in the first interest rate table,
means for generating an updated first interest rate table in accordance with the instructions, and
means for dynamically building a second table of rates according to the benefit plan provisions using the updated first interest rate table.

32. The system of claim 29, wherein the calculation module performs the calculation according to user-defined guidelines associated with the provisions.

33. The system of claim 32, wherein the user-defined guidelines indicate at least one event and at least one corresponding action to perform in response to the event.

34. The system of claim 29, wherein the calculation includes a service accrual calculation for the beneficiary.

35. The system of claim 34, wherein the calculation module calculates the service accrual by evaluating an employment history associated with the beneficiary.

36. The system of claim 35, wherein the calculation module calculates the service accrual by evaluating employment status changes associated with the employment history.

37. The system of claim 36, wherein the calculation module calculates the service accrual according to user-defined guidelines corresponding to the employment status changes, said guidelines directing the calculation module to perform an action for each employment status change.

38. The system of claim 29, further comprising information means for storing at least one of census information, market rates, historical interest rates, economic indices, and regulatory provisions.

39. The system of claim 29, wherein the calculation means includes means for using the information means to perform the calculation.

40. A computer-readable medium containing instructions for controlling a computer system coupled to a network to perform a method, the computer system having a processor for executing the instructions, and the method comprising:
receiving a request to perform a benefit calculation;
identifying a system plan using information in the request;
accessing the system plan from a repository; and
performing the benefit calculation using provisions, created by a user via an expression language, associated with the system plan.
